(19) United States
(12) Patent Application Publication
(10) Pub. No.: US 2026/0257487 A1
(43) Pub. Date: Sep. 3, 2026

(54) INKJET RECORDING APPARATUS

(71) Applicant: KEYENCE CORPORATION, Osaka (JP)

(72) Inventors: Takanori Ando, Osaka-shi (JP); Minoru Taneda, Osaka-shi (JP); Atsushi Kitamura, Osaka-shi (JP)

(73) Assignee: KEYENCE CORPORATION, Osaka (JP)

(21) Appl. No.: 19/656,057

(22) Filed: Apr. 23, 2026

Related U.S. Application Data
(63) Continuation of application No. PCT/JP2024/037288, filed on Oct. 19, 2024.

(30) Foreign Application Priority Data
Oct. 31, 2023 (JP) 2023-186848
Oct. 9, 2024 (JP) 2024-177066

(51) Int. Cl. B41J 2/175; B41J 2/03; B41J 2/085; B41J 2/09; B41J 2/185; B41J 25/34; B41J 29/393

(52) U.S. Cl. CPC B41J 2/17596; B41J 2/03; B41J 2/085; B41J 2/09; B41J 2/185; B41J 25/34; B41J 29/393; B41J 2002/1853

(57) ABSTRACT

The manufacturing efficiency of the inkjet recording apparatus is enhanced, and eventually, the productivity thereof is improved. An inkjet recording apparatus includes a print head, a controller, and a connection cable that connects the print head and the controller and supplies ink from the controller to the print head. The print head includes a head main body to which the connection cable is connected and that supplies ink to a nozzle via the connection cable, and a head module that is mountable on and dismountable from the head main body and accommodates the nozzle, a charging electrode, a deflection electrode, and a gutter. The connection cable or the head main body is provided with a valve that opens and closes an ink supply path to the nozzle. The head module is provided with a high-voltage generation unit that generates a high voltage to be applied to the deflection electrode.

### CROSS-REFERENCE TO RELATED APPLICATIONS

The present application is a continuation of International Application No. PCT/JP2024/037288,

filed October 19, 2024, and claims foreign priority based on Japanese Patent Application No. 2023-186848, filed October 31, 2023, and No. 2024-177066, filed October 9, 2024, the contents of which are incorporated herein by references.

### BACKGROUND OF THE INVENTION

### 1. TECHNICAL FIELD

The present disclosure relates to a continuous inkjet recording apparatus.

### 2. DESCRIPTION OF THE RELATED ART

JP 2021-091181 A discloses an example of a continuous inkjet recording apparatus. Specifically, JP 2021-091181 A discloses an inkjet recording apparatus including a print head, a controller, and a connection cable that electrically and fluidly connects the print head and the controller.

According to JP 2021-091181 A, the print head accommodates a nozzle that ejects ink or a solvent, a charging electrode that charges the ink, a deflection electrode that deflects the ink, and a gutter that collects non-deflected ink or a solvent.

As described in JP 2021-091181 A, the nozzle, the charging electrode, the deflection electrode, and the gutter are accommodated in the print head.

Therefore, a connection cable connecting the controller and the print head includes a plurality of conduits and electric wires, such as a supply pipe for supplying ink, a collection pipe for collecting ink, and an electric wire for applying a predetermined voltage to a charging electrode and a deflection voltage.

In the case of using the connection cable as in JP 2021-091181 A, the inkjet recording apparatus has a so-called integrated configuration in which the print head and the controller are connected via the connection cable.

Incidentally, in general, when manufacturing a print head, an operation (installation operation) of installing and bonding a charging electrode, a deflection electrode, and the like in the print head is required. After the installation operation is completed, an operation (drying operation) of drying the print head in a high-temperature chamber is also required. In addition, various inspections may be performed in parallel with the drying operation or before and after the drying operation. As such an inspection, for example, an inspection related to operation of a nozzle installed in a print head is conceivable.

However, in the case of using the integrated configuration as described above, the presence of such an operation and inspection hinders improvement in productivity in the inkjet recording apparatus.

For example, in a drying operation, not only a print head but also a controller needs to be placed in a high-temperature chamber together. Therefore, it takes a complicated time and effort to secure an installation space of the controller or bring the controller in, and as a result, it hinders improvement in productivity.

In addition, in a case where an abnormality occurs in various inspections of the print head, even if there is no problem in the controller, a product as the entire inkjet recording apparatus is not completed until the abnormality of the print head is eliminated, and thus, productivity improvement is also hindered.

### SUMMARY OF THE INVENTION

The present disclosure has been made in view of such a point, and an object of the present disclosure is to increase the manufacturing efficiency of an inkjet recording apparatus, and eventually improve the productivity thereof.

A first aspect of the present disclosure relates to a continuous inkjet recording apparatus including: a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside; a controller including an ink supply unit that supplies ink to the print head, and a control unit that controls ink supply from the ink supply unit to the print head; and a cable that connects the print head and the controller and supplies ink from the controller to the print head.

According to the first aspect of the present disclosure, the print head includes a head main body to which the cable is connected, and supplies ink to the nozzle via the cable, and a head module that is mountable on and dismountable from the head main body, and accommodates the nozzle, the charging electrode, the deflection electrode, and the gutter, and the cable or the head main body is provided with a valve that opens and closes a flow path through which ink or a solvent flows between the cable or the head main body and the head module, and the head module is provided with a high-voltage generation unit that generates a high voltage to be applied to the deflection electrode.

According to the first aspect, a part of the print head is modularized as a head module that is mountable on and dismountable from the head main body. In the head module, the nozzle, the charging electrode, and the deflection electrode are accommodated, and the high-voltage generation unit for generating a high voltage (for example, several kv) for the deflection electrode is incorporated.

Since the high-voltage generation unit is incorporated in the head module, a high voltage signal caused by the high-voltage generation unit is not transmitted and received between the head main body and the head module. Therefore, the insulation distance can be shortened, and the connection portion between the head main body and the head module can be simplified or made compact.

By using such a head module, it is possible to remove the head module from the head main body and dry the head module at the time of manufacturing the inkjet recording apparatus, or replace the head module with another head module having no abnormality when there is an abnormality in inspection of the head module to complete a product. As a result, the manufacturing efficiency of the inkjet recording apparatus can be enhanced, and eventually, the productivity can be improved.

According to a second aspect of the present disclosure, the valve may transition from an open state to a closed state by receiving a control signal from the control unit when the head module is removed from the head main body.

According to the second aspect, leakage of ink from the head main body can be suppressed when the head module is removed from the head main body at the time of manufacturing the inkjet recording apparatus.

In general, the leakage of ink contaminates the surrounding environment of the factory, and thus it takes time and effort to clean the leakage of ink. In consideration of such trouble, the leakage of ink is disadvantageous in enhancing the manufacturing efficiency of the inkjet recording apparatus.

On the other hand, by suppressing the leakage of ink as in the second aspect, the productivity of the inkjet recording apparatus can be improved.

According to a third aspect of the present disclosure, the head main body or the head module may include a sensor that detects that the head module is removed from the head main body.

Furthermore, according to a fourth aspect of the present disclosure, the control unit may prohibit application of a high voltage signal to the charging electrode on condition that the head module is removed from the head main body.

According to the fourth aspect, when the head module is removed, electric shock to the user can be prevented without turning off the controller. Therefore, the head module can be safely removed even in the live state. As a result, various manufacturing steps can be efficiently performed, and the productivity of the inkjet recording apparatus can be improved.

Furthermore, according to a fifth aspect of the present disclosure, the head module may include a storage unit that stores at least one of information indicating an ink type, information on a life of the inkjet recording apparatus, and correction information for adjusting a high voltage by the high-voltage generation unit.

According to the fifth aspect, by providing the storage unit in the head module, information can be read from the head module alone without moving the print head and eventually, the entire inkjet recording apparatus. As a result, various inspections can be efficiently performed, and eventually, the productivity of the inkjet recording apparatus can be improved.

Further, according to a sixth aspect of the present disclosure, the print head may include a first lock mechanism that restricts detachment of the head module from the head main body, and a second lock mechanism that further restricts release of restriction by the first lock mechanism.

According to the sixth aspect, by providing not only the first lock mechanism but also the second lock mechanism, unintended detachment due to human error can be suppressed. As a result, various manufacturing steps can be efficiently performed, and the productivity of the inkjet recording apparatus can be improved.

Furthermore, according to a seventh aspect of the present disclosure, the inkjet recording apparatus may further include an attachment portion that is connected to the head main body and positions and fixes the print head.

According to the seventh aspect, stress acting on the connection portion between the head main body and the head module, particularly stress received from the cable can be alleviated. This can stabilize print head positioning.

Furthermore, according to an eighth aspect of the present disclosure, the inkjet recording apparatus may further include an attachment portion that is connected to the head module and positions and fixes the print head.

According to the eighth aspect, by providing the attachment portion in the head module located on the distal end side of the print head, the landing position of the ink ejected from the head module can be stabilized. As a result, the printing accuracy of the print head can be stabilized.

As described above, according to the present disclosure, the manufacturing efficiency of the inkjet recording apparatus can be enhanced, and eventually, the productivity thereof can be improved.

### BRIEF DESCRIPTION OF THE DRAWINGS

FIG. 1 is a diagram illustrating an overall configuration of an inkjet recording system;

FIG. 2A is a block diagram illustrating a schematic configuration of an inkjet recording apparatus;

FIG. 2B is a block diagram illustrating the schematic configuration of the inkjet recording apparatus;

FIG. 3 is a diagram illustrating a schematic configuration of a print head;

FIG. 4 is a diagram illustrating paths of ink and a solvent in the inkjet recording apparatus;

FIG. 5A is an exploded perspective view illustrating a configuration of a head main body and a head module;

FIG. 5B is a perspective view illustrating a print head after assembly;

FIG. 6A is a perspective view illustrating a structure of a first engagement portion of the head main body;

FIG. 6B is a perspective view illustrating a structure of a second engagement portion of the head module;

FIG. 7 is a flowchart illustrating a removal sequence in a normal state;

FIG. 8 is a flowchart illustrating a removal sequence in an abnormal state;

FIG. 9 is a flowchart illustrating a mounting sequence;

FIG. 10A is a diagram corresponding to FIG. 5A illustrating a configuration of a head main body and a head module according to a first modification;

FIG. 10B is a diagram corresponding to FIG. 5B illustrating the print head after assembly according to the first modification;

FIG. 11A is a perspective view illustrating first and second lock mechanisms;

FIG. 11B is a perspective view illustrating the first and second lock mechanisms;

FIG. 12 is a side view illustrating operation of the first and second lock mechanisms;

FIG. 13 is a diagram corresponding to FIG. 8 illustrating a removal sequence according to the first modification;

FIG. 14 is a diagram corresponding to FIG. 9 illustrating a mounting sequence according to the first modification;

FIG. 15 is a diagram illustrating a display screen according to the first modification;

FIG. 16 is a diagram illustrating the display screen according to the first modification;

FIG. 17 is a diagram corresponding to FIG. 3 illustrating a print head according to a second modification;

FIG. 18 is a side view illustrating an attachment portion in the present embodiment;

FIG. 19 is a diagram corresponding to FIG. 18 illustrating the attachment portion according to the second modification;

FIG. 20 is a diagram corresponding to FIG. 3 illustrating a print head according to a third modification; and

FIG. 21 is a diagram corresponding to FIG. 4 illustrating an inkjet recording apparatus according to the third modification.

### DETAILED DESCRIPTION

Hereinafter, embodiments of the present disclosure will be described with reference to the drawings. Note that the following description is an example.

That is, in the present specification, an industrial inkjet printer will be described as an example of an inkjet recording apparatus, but the technology disclosed herein can be applied to a general device configured to cause particulate ink to fly and land on a print object such as a workpiece regardless of the names of the inkjet recording apparatus and the industrial inkjet printer.

Furthermore, in the present specification, printing by the inkjet recording apparatus will be described, but the "printing" referred to herein includes all processing processes to which inkjet is applied, such as printing of characters and marking of figures.

### <Overall Configuration>

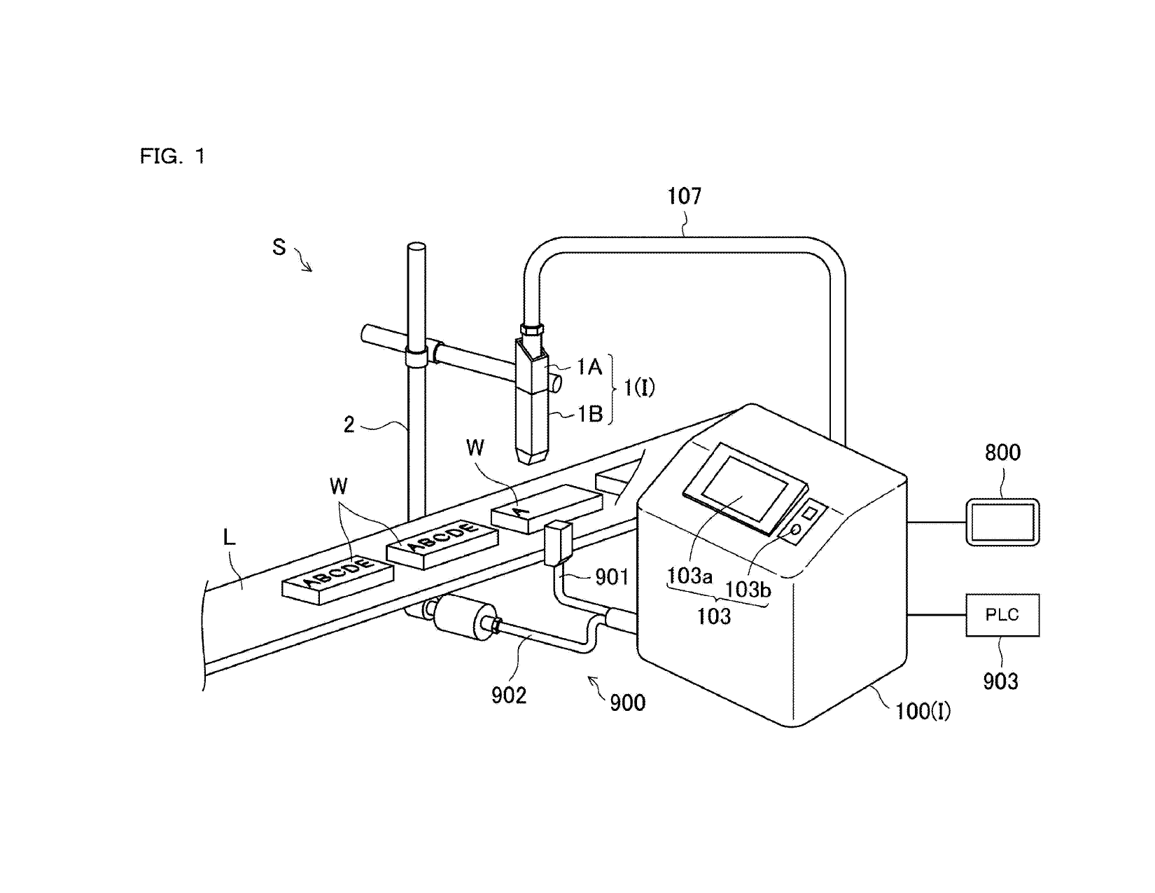

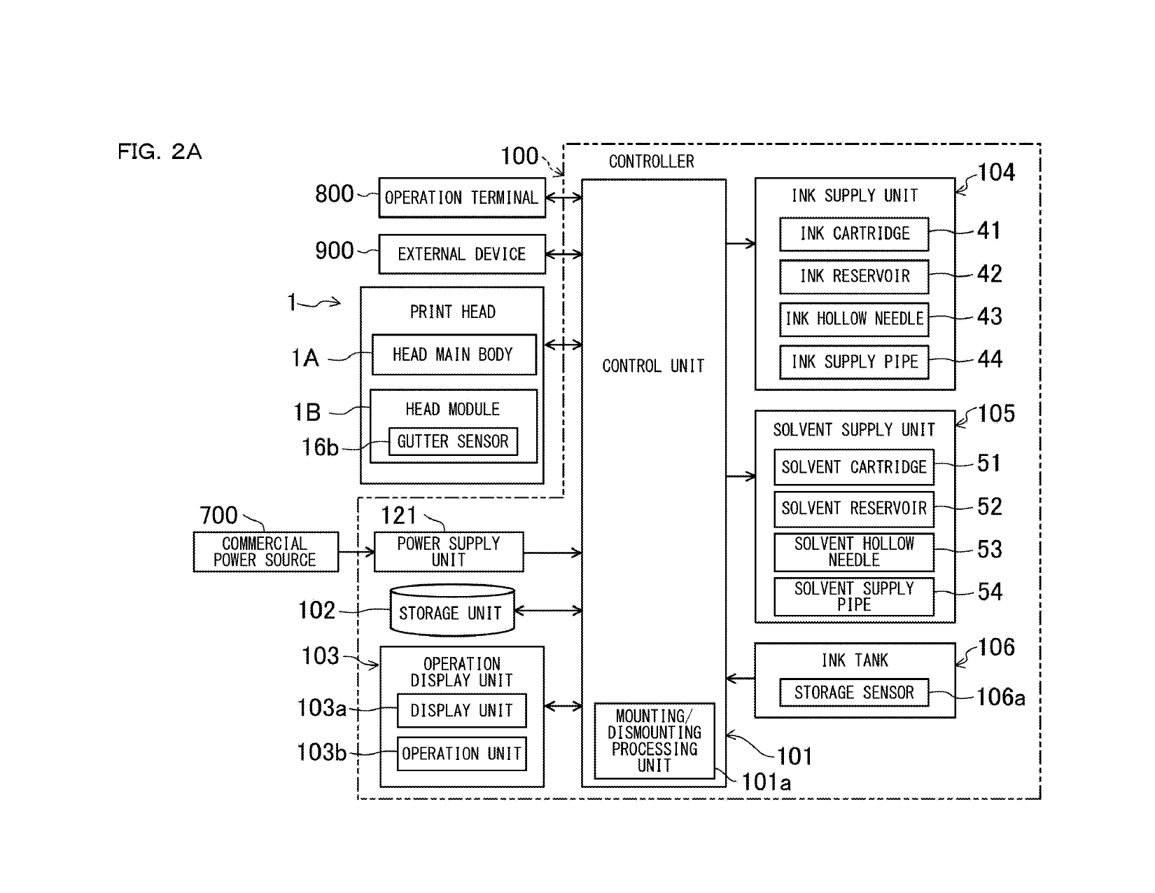

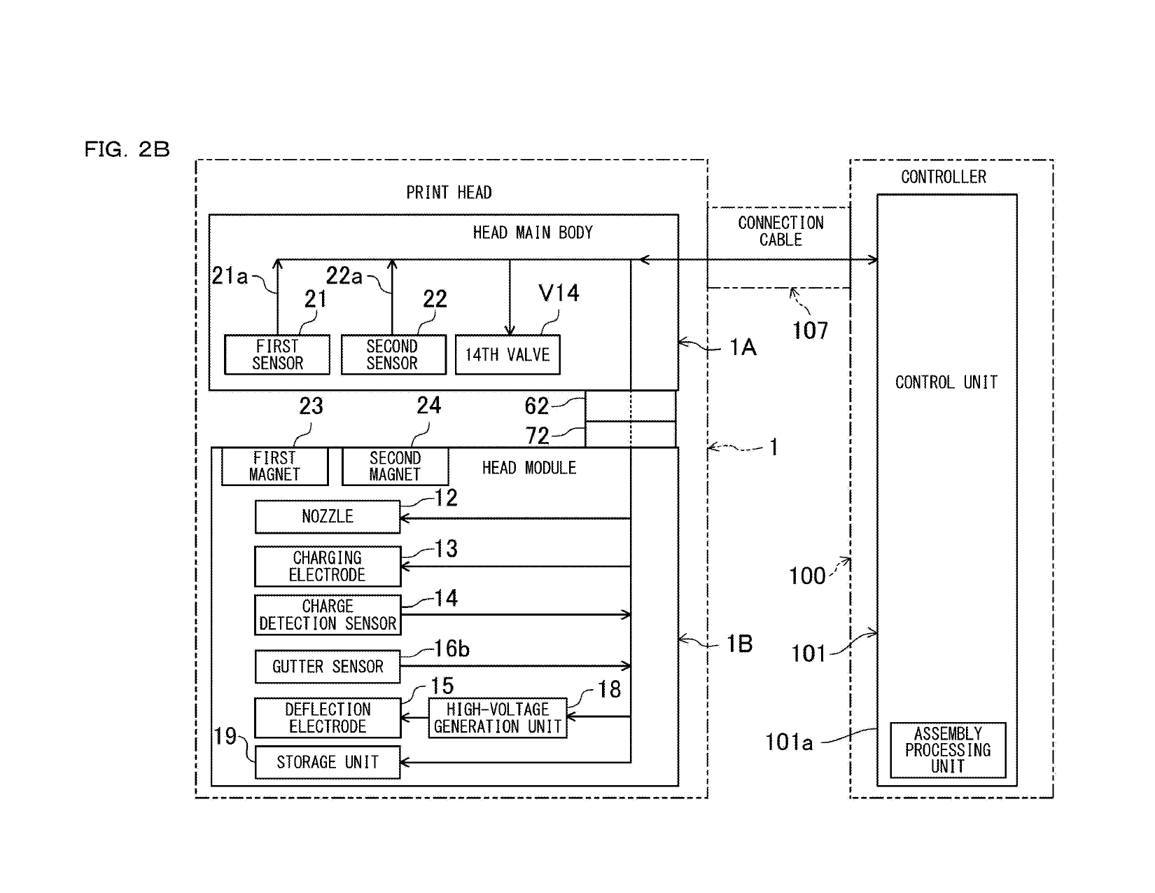

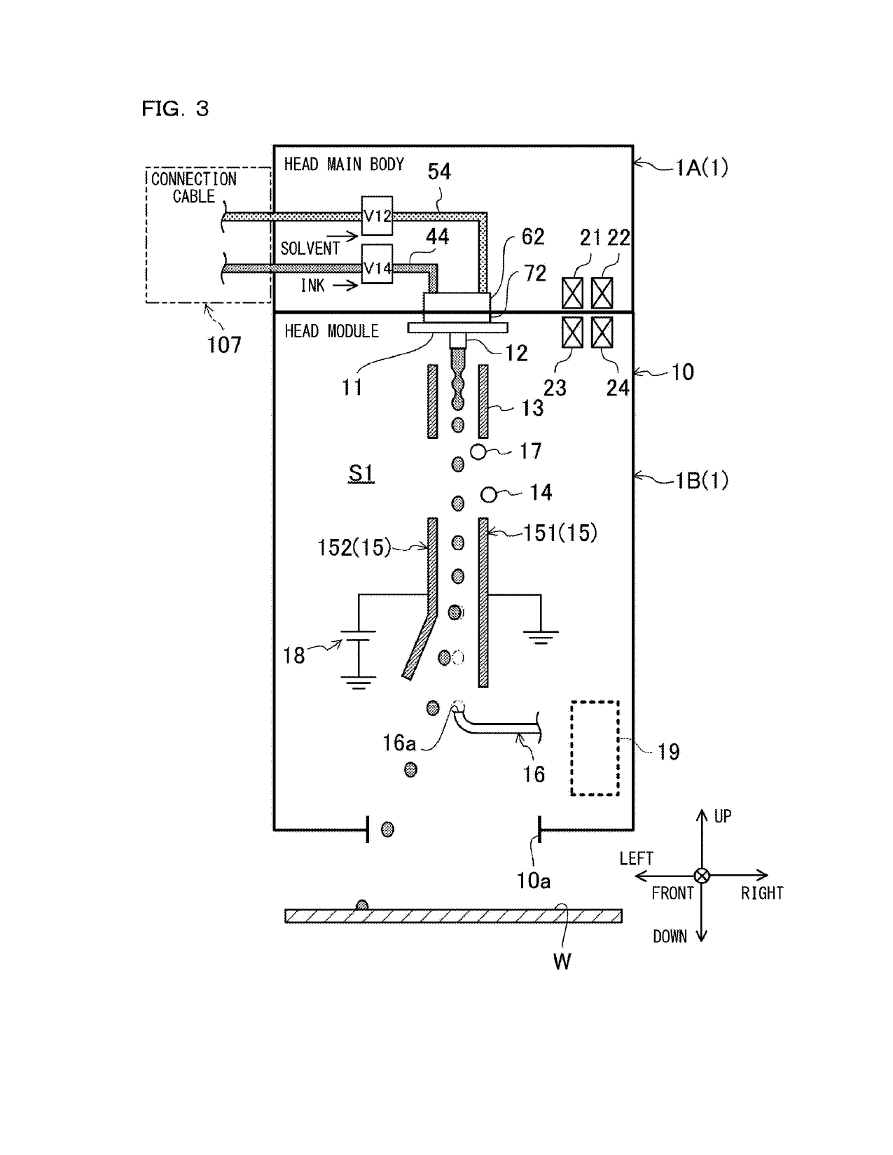

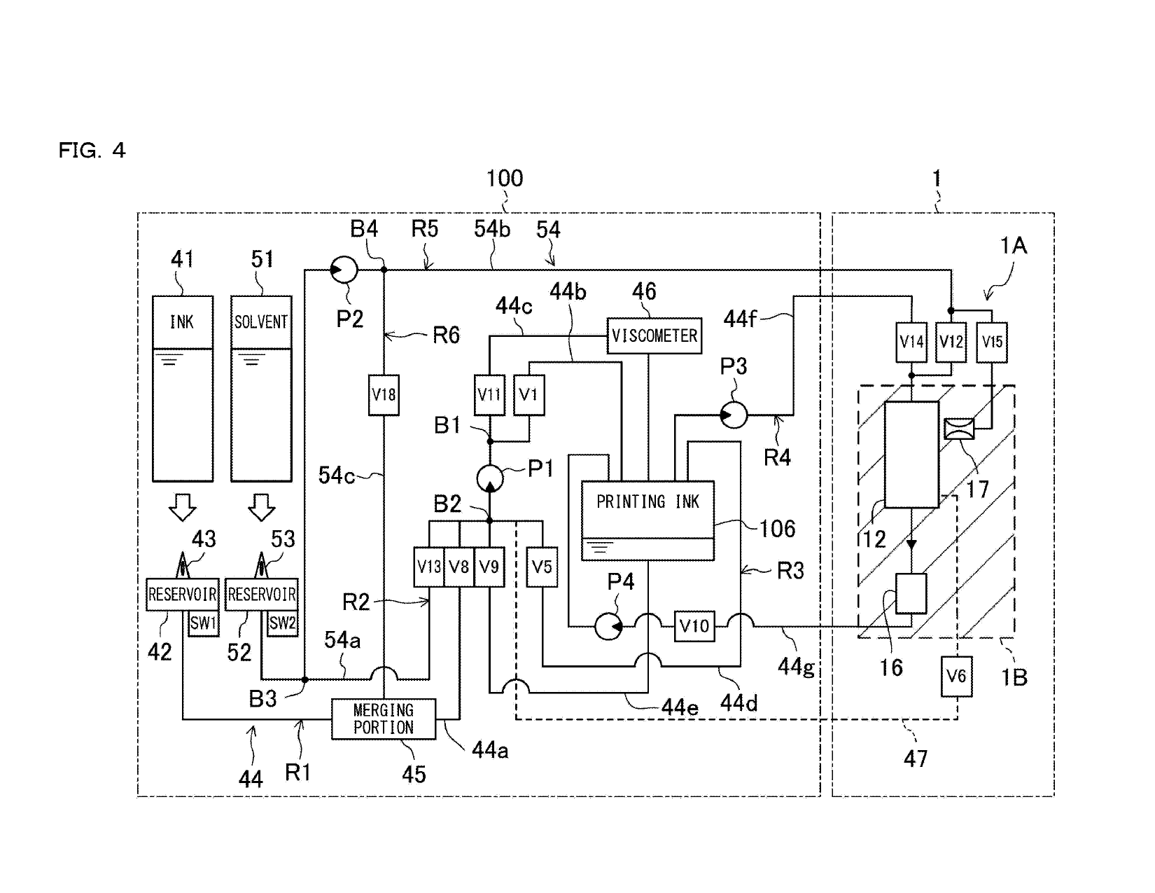

FIG. 1 is a diagram illustrating an overall configuration of an inkjet recording system S. FIGS. 2A and 2B are diagrams illustrating a schematic configuration of an inkjet recording apparatus I, and FIG. 3 is a diagram illustrating a schematic configuration of a print head 1 in the inkjet recording apparatus I. FIG. 4 is a diagram illustrating paths of ink and a solvent in the inkjet recording apparatus I.

An inkjet recording system S exemplified in FIG. 1 is installed in a conveyance line L in a factory or the like, for example, and is configured to sequentially perform printing on each print object W flowing through the conveyance line L. Note that the application target of the present disclosure is not limited to the inkjet recording system S. The present invention can be applied to a printing system using a method other than the automatic method. The conveyance line L can be configured by, for example, a belt conveyor or the like. The term "print object" may be referred to as a "printing target object" in the following description.

Specifically, the inkjet recording system S includes an inkjet recording apparatus I that performs printing by landing particulate ink (ink particles) on the print object W, and an operation terminal 800 and an external device 900 connected to the inkjet recording apparatus I. Note that the operation terminal 800 and the external device 900 are not essential.

The inkjet recording apparatus I exemplified in FIGS. 1 to 3 includes the print head 1 that ejects ink particles from the nozzles 12 and causes the ink particles to land on the print object W, and a controller 100 that supplies a control signal, ink, and a solvent to the print head 1. The controller 100 supplies a control signal to the print head 1 to control the locus of the ink particles. Thus, the landing position of the ink particles on the print object W is adjusted, and desired printing is realized. The print head 1 is fixed at a predetermined position by a support member 2 or the like.

The inkjet recording apparatus I is a continuous inkjet recording apparatus (continuous inkjet printer: CIJ). That is, in order to prevent clogging (in particular, clogging of the nozzle 12) and the like due to volatilization of the ink, even when the inkjet recording apparatus I is not executing printing, the ink always circulates inside the inkjet recording apparatus I as long as the inkjet recording apparatus I is in an operating state. By adopting the continuous type, a quick-drying ink can be used without causing clogging by the ink.

Furthermore, the inkjet recording apparatus I according to the present embodiment can adjust the concentration (viscosity) of the ink by mixing the solvent and the ink. Furthermore, the inkjet recording apparatus I can clean each unit in the print head 1 such as the nozzle 12 by sending out a solvent to the print head 1. The solvent used for cleaning can be recovered as necessary and reused to adjust the concentration (viscosity) of the ink.

In order to realize the circulation of the ink, the print head 1 includes a gutter 16 that recovers the ink or the solvent ejected from the nozzle 12 in addition to the nozzle 12 that ejects the ink or the solvent (see FIG. 3). The ink or solvent fed from the controller 100 to the print head 1 is ejected from the nozzle 12 and collected by the gutter 16. The ink or solvent thus recovered is sent back to the controller 100 to be reused. By repeating such steps, the ink can be circulated.

On the other hand, the operation terminal 800 includes, for example, a central processing unit (CPU) and a storage device, and is connected to the controller 100. The operation terminal 800 defines print settings and functions as a terminal for indicating information related to printing to the user.

The print settings set by the operation terminal 800 are output to the controller 100 and stored in the storage unit 102. In addition to the storage unit 102 of the controller 100 or instead of the storage unit 102, the operation terminal 800 may store the print settings.

Note that the print setting according to the present embodiment may include conditions and parameters related to a mounting/dismounting process to be described later, in addition to the contents of the character string and the like to be printed.

Note that the operation terminal 800 can be incorporated in and integrated with the controller 100, for example. In this case, the term "control unit" or the like is used instead of the term "operation terminal".

The external device 900 is connected to the controller 100 as necessary. In the example illustrated in FIGS. 1 and 2A, a workpiece detection sensor 901, a conveyance speed sensor 902, and a programmable logic controller (PLC) 903 are provided as the external device 900.

Specifically, the workpiece detection sensor 901 detects the presence or absence of the print object W on the conveyance line L, and outputs a signal (detection signal) indicating the detection result to the controller 100. The detection signal output from the workpiece detection sensor 901 functions as a trigger (print trigger) for starting printing.

The conveyance speed sensor 902 includes, for example, a rotary encoder, and can detect the conveyance speed of the print object W. The conveyance speed sensor 902 outputs a signal (detection signal) indicating the detection result to the controller 100. The controller 100 controls timing and the like of ejecting the ink particles from the print head 1 based on the detection signal input from the conveyance speed sensor 902.

As exemplified in FIG. 2A, the PLC 903 is electrically connected to the controller 100. The PLC 903 is used to control the inkjet recording system S according to a predetermined sequence.

In addition to the devices and apparatuses described above, a device for performing operation and control, a computer for performing other various processes, a storage device, a peripheral device, and the like can be connected to the inkjet recording apparatus I. The connection method in this case may be either wired connection or wireless connection.

### <Controller 100>

The controller 100 is configured to electrically control the print head 1 and supply printing ink and a solvent for diluting the ink to the print head 1.

Specifically, the controller 100 according to the present embodiment includes, as components related to electrical control, a storage unit 102 that stores the above-described print settings, a control unit 101 that controls the controller 100 and each unit of the print head 1, an operation display unit 103 that receives an operation by a user and displays information to the user, and a power supply unit 121 that guides power supplied from the outside to the control unit 101.

The controller 100 also includes an ink supply unit 104, a solvent supply unit 105, and an ink tank 106 as components related to supply of ink and the like. These components are in direct or indirect fluid connection with the print head 1. In at least the present embodiment, the controller 100 accommodates the ink supply unit 104, the solvent supply unit 105, and the control unit 101 therein.

The ink supply unit 104 includes an ink reservoir 42 that removably receives an ink cartridge 41 in which ink is stored. The ink supply unit 104 supplies ink to the print head 1.

Meanwhile, the solvent supply unit 105 includes a solvent reservoir 52 that removably receives a solvent cartridge 51 in which a solvent is stored. The solvent supply unit 105 supplies a solvent to the print head 1.

Further, the ink tank 106 stores the ink from the ink cartridge 41 received in the ink reservoir 42 and the solvent from the solvent cartridge 51 received in the solvent reservoir 52 as printing ink. The "printing ink" herein means a mixture of a solvent and ink (for example, ink whose concentration is adjusted by a solvent).

Then, the print head 1 performs printing with the printing ink from the ink tank 106. The print head 1 also cleans each unit in the print head 1, such as the nozzle 12, with the solvent supplied from the solvent supply unit 105 while bypassing the ink tank 106.

Note that the control unit 101, the ink supply unit 104, and the solvent supply unit 105 may be configured as separate units. The storage unit 102 may also be configured as a separate unit from the ink supply unit 104 and the solvent supply unit 105. The operation display unit 103 may also be configured as a separate unit from the ink supply unit 104 and the solvent supply unit 105. Also in these cases, the components can be combined into the controller 100.

Furthermore, considering the ink supply unit 104 and the ink tank 106 as independent components is merely a classification for convenience. From the viewpoint of being related to the supply of ink, the ink tank 106 may be regarded as an element of the ink supply unit 104.

(Storage Unit 102)

The storage unit 102 is configured to store print settings set via the operation display unit 103 or the operation terminal 800 described later, and output the stored print settings to the control unit 101 on the basis of a control signal from the outside.

Specifically, the storage unit 102 is configured using a volatile memory, a nonvolatile memory, a solid-state drive (SSD), a hard disk drive (HDD), or the like, and can temporarily or continuously store information indicating print settings. When the operation terminal 800 is incorporated in the controller 100, the operation terminal 800 may also serve as the storage unit 102.

### (Control Unit 101)

The control unit 101 is a processing unit that controls ink supply from the ink supply unit 104 to the print head 1 and controls solvent supply from the solvent supply unit 105 to the print head 1.

Specifically, the control unit 101 controls at least the ink supply unit 104 and the solvent supply unit 105 in the controller 100 and the nozzle 12, the charging electrode 13, and the deflection electrode 15 in the print head 1 based on the print settings stored in the storage unit 102. By controlling each unit by the control unit 101, printing on the printing target object W is performed at a predetermined timing.

More specifically, the control unit 101 includes, for example, a CPU, a memory, an input/output bus, and the like, and generates a control signal on the basis of a signal indicating information input via the operation display unit 103 or the operation terminal 800 and a signal indicating a print setting read from the storage unit 102. The control unit 101 outputs the control signal thus generated to the controller 100 and each unit of the inkjet recording apparatus I to control printing on the print object W.

For example, when printing is performed on the printing target object W, the control unit 101 reads the print content on the printing target object W stored in the storage unit 102 and generates a control signal based on the print content. Then, the control unit 101 outputs the control signal to the charging electrode 13 to set the flying direction of the ink particles so as to realize the landing position corresponding to the print content.

### -Other Functional Elements in the Control Unit 101-

In addition, the control unit 101 according to the present embodiment includes a mounting/dismounting processing unit 101a exemplified in FIG. 2A as a functional element that executes a process related to the mounting/dismounting process. Details of the mounting/dismounting processing unit 101a will be described later.

### (Operation Display Unit 103)

As illustrated in FIG. 1, the operation display unit 103 includes a display unit 103a that displays information to the user and an operation unit 103b that receives an operation by the user. The operation display unit 103 can be provided in, for example, a housing or the like constituting the controller 100, but may be configured separately from the housing and set at a location different from the housing. When the operation terminal 800 is incorporated in the controller 100, the operation terminal 800 may also serve as the operation display unit 103.

The display unit 103a displays various types of information related to the inkjet recording apparatus I. The display unit 103a includes, for example, a liquid crystal display panel, an organic EL display panel, or the like, and changes a display mode in response to a control signal from the control unit 101. The display unit 103a can display a user interface for operating each unit of the inkjet recording system S, a user interface for setting print settings, and a user interface related to the mounting/dismounting process described above.

The operation unit 103b includes, for example, a touch operation panel, a button, a switch, and the like. When the user operates the operation unit 103b, information (operation information) corresponding to the operation input is input to the control unit 101, and the control unit 101 can detect what operation has been performed. For example, by operating the operation unit 103b, it is possible to switch the power ON/OFF and the like of the inkjet recording apparatus I, and to perform various settings, input information, and the like.

The operation display unit 103 can also set print settings similarly to the operation terminal 800 described above. The print settings set by the operation display unit 103 are output to the controller 100 and stored in the storage unit 102. In the following description, it is assumed that the user operates the operation display unit 103, but the operation terminal 800 may be used instead of the operation display unit 103.

### (Ink Supply Unit 104)

The ink supply unit 104 supplies the ink from the ink cartridge 41 to the nozzles 12 of the print head 1 as printing ink. At this time, the ink from the ink supply unit 104 is supplied to the print head 1 via the ink tank 106.

Specifically, the ink supply unit 104 according to the present embodiment includes, as main components, the ink cartridge 41 and the ink reservoir 42 described above, an ink hollow needle 43 as a hollow needle, and an ink supply pipe 44. The ink hollow needle 43 fluidly connects the ink cartridge 41 and the ink supply pipe 44. The ink supply pipe 44 fluidly connects the ink cartridge 41 and the print head 1 via the ink hollow needle 43. The ink tank 106 is arranged in the middle of the ink supply pipe 44 from the ink hollow needle 43 to the print head 1.

Among them, the ink cartridge 41 stores ink. The ink reservoir 42 removably receives the ink cartridge 41. By replacing the ink cartridge 41 with respect to the ink reservoir 42, ink can be replenished to the ink tank 106. That is, the inkjet recording apparatus I according to the present embodiment is configured as a so-called "cartridge type" inkjet printer.

As illustrated only in FIG. 4, the ink reservoir 42 is provided with a first attachment sensor SW1 that detects attachment of the ink cartridge 41 or the solvent cartridge 51 to the ink reservoir 42.

The ink hollow needle 43 accesses the ink in the ink cartridge 41 when the ink reservoir 42 receives the ink cartridge 41 (when the ink cartridge 41 is mounted to the ink reservoir 42).

The ink supply pipe 44 constitutes a path for supplying printing ink to the print head 1. Ink can be circulated between the print head 1 and the controller 100 by a path constituted by the ink supply pipe 44.

As described later, the ink supply pipe 44 is provided with a plurality of on-off valves including a first valve V1 and a plurality of pumps including a first pump P1. Among these, each on-off valve is constituted by an electromagnetic valve. Each on-off valve can open and close in response to a control signal output from the control unit 101 to control the flow of ink. On the other hand, each pump receives the control signal output from the control unit 101 to pressure-feed the ink, and can control the flow of the ink similarly to the on-off valve. At least a part of the opening and closing (for example, the first valve V1, an eighth valve V8, an 11th valve V11, and an 18th valve V18 in FIG. 4) may be a manual cock instead of the electromagnetic valve.

### (Solvent Supply Unit 105)

The solvent supply unit 105 supplies the solvent from the solvent cartridge 51 to the ink tank 106 similarly to the ink, or supplies the solvent alone to the nozzle 12. The former solvent forms a printing ink together with the ink by adjusting the density of the ink, and is supplied to the print head 1.

Here, in a case of configuring the printing ink together with the ink (that is, when printing is performed on the print head 1), the solvent from the solvent supply unit 105 is guided to the nozzle 12 through the ink tank 106. On the other hand, when supplied as a solvent alone, the solvent from the solvent supply unit 105 is guided to the nozzle 12 without passing through the ink tank 106.

Specifically, the solvent supply unit 105 according to the present embodiment includes, as main components, the solvent cartridge 51 and the solvent reservoir 52 described above, a solvent hollow needle 53, and a solvent supply pipe 54. The solvent hollow needle 53 fluidly connects the solvent cartridge 51 and the solvent supply pipe 54. The solvent supply pipe 54 fluidly connects the solvent cartridge 51 to the print head 1 and to the ink tank 106 via the solvent hollow needle 53.

Among them, a solvent is stored in the solvent cartridge 51. The solvent reservoir 52 removably receives the solvent cartridge 51. By replacing the solvent cartridge 51 with respect to the solvent reservoir 52, it is possible to replenish the solvent for concentration adjustment and the cleaning solvent. That is, the inkjet recording apparatus I according to the present embodiment is also configured as a "cartridge type" inkjet printer for the solvent.

As illustrated only in FIG. 4, the solvent reservoir 52 is provided with a second attachment sensor SW2 that detects attachment of the solvent cartridge 51 or the ink cartridge 41 to the solvent reservoir 52.

The solvent hollow needle 53 accesses the solvent in the solvent cartridge 51 when the solvent reservoir 52 receives the solvent cartridge 51 (when the solvent cartridge 51 is mounted to the solvent reservoir 52).

The solvent supply pipe 54 constitutes a path for supplying a solvent to the ink tank 106 or supplying a solvent to the print head 1 without interposing the ink tank 106. By these paths, the printing ink can be generated from the ink and the solvent, and the print head 1 can be cleaned with the solvent.

Note that the classification of the ink supply pipe 44 and the solvent supply pipe 54 is merely a classification for convenience made to simplify the description. The ink supply pipe 44 and the solvent supply pipe 54 are substantially inseparable because they are connected to each other or one serves as the other.

As described later, the solvent supply pipe 54 is provided with a plurality of on-off valves including a 12th valve V12 and a plurality of pumps including a second pump P2. Among these, each on-off valve is constituted by an electromagnetic valve. Each on-off valve can open and close in response to a control signal output from the control unit 101 to control the flow of the solvent. On the other hand, each pump receives a control signal output from the control unit 101 to pressure-feed the solvent, and can control the flow of the solvent similarly to the electromagnetic valve. As described above, a manual cock may be used instead of the electromagnetic valve.

### (Ink Tank 106)

The ink tank 106 is configured to store ink from the ink cartridge 41 and a solvent from the solvent cartridge 51. Specifically, the ink tank 106 is constituted by a container that stores ink whose concentration (viscosity) is adjusted by a solvent, that is, a mixture of ink and solvent.

The printing ink supplied from the ink tank 106 to the nozzles 12 lands on the surface of the print object W at the time of printing, and is collected by the gutter 16 and sent back to the ink tank 106 at the time of non-printing. This achieves circulation of the printing ink.

Furthermore, the solvent supplied to the nozzle 12 for cleaning is also collected by the gutter 16, and then sent to the ink tank 106 via, for example, a conditioning tank (not illustrated) dedicated to the solvent, and can be reused for the concentration adjustment of the ink.

The ink tank 106 is provided with a storage sensor 106a for detecting a liquid level (so-called liquid surface level) in the tank. The storage sensor 106a is electrically connected to the control unit 101, and inputs a detection signal thereof to the controller 100. The storage sensor 106a may be an electrode type level sensor, a float type level sensor, or a capacitance type level sensor.

### (Power Supply Unit 121)

The power supply unit 121 is interposed between a commercial power source 700 and the control unit 101, and can relay power supplied from the commercial power source 700 and supply the power to the control unit 101.

### (Other Components)

The controller 100 is provided with a connection cable 107 in which a power supply wire for transmitting and receiving a control signal, a tube (specifically, the tube constituting the ink supply pipe 44) for transmitting and receiving ink, and a tube (specifically, a tube constituting the solvent supply pipe 54) for transmitting and receiving a solvent are covered in a bundle. This connection cable 107 is flexible and is connected to the upper end of the print head 1 (see FIG. 1). The controller 100 and the print head 1 are electrically and fluidly connected via this connection cable 107.

The connection cable 107 connects the print head 1 and the controller 100, and can supply ink from the controller 100 to the print head 1, and exemplifies a "cable" in the present embodiment.

### <Print Head 1>

The print head 1 ejects ink (printing ink) whose density has been adjusted based on a control signal, ink, and solvent supplied from the controller 100 as particulate ink (hereinafter, also referred to as "ink particles"). The print head 1 can perform printing on the print object W by deflecting the flying direction of the ejected ink particles and causing the deflected ink particles to land on the surface of the print object W. The details of printing at that time are in accordance with the printing setting described above. The print head 1 can sequentially perform printing on each of the print objects W according to the print setting.

Specifically, as illustrated in FIG. 3, the print head 1 according to the present embodiment includes a pressurizer 11, a nozzle 12, a charging electrode 13, a deflection electrode 15, a gutter 16, a cleaning nozzle 17, a high-voltage generation unit 18, and a storage unit 19. The pressurizer 11 pressurizes the printing ink to form a particulate ink. The nozzle 12 ejects particulate ink. The charging electrode 13 charges the particulate ink ejected from the nozzle 12. The deflection electrode 15 deflects flight deflection of the printing ink charged by the charging electrode 13. The gutter 16 collects the printing ink not deflected by the deflection electrode 15 or the solvent ejected from the nozzle 12.

In addition, as elements related to acquisition of various parameter values, the print head 1 includes a charge detection sensor 14 that monitors a charge state of the printing ink, and a gutter sensor 16b that detects whether or not the ink is in the gutter 16.

The print head 1 accommodates the pressurizer 11, the nozzle 12, the charging electrode 13, the charge detection sensor 14, the deflection electrode 15, the gutter 16, the cleaning nozzle 17, the high-voltage generation unit 18, and the storage unit 19 therein, and ejects the printing ink deflected by the deflection electrode 15 to the outside. Then, the inkjet recording apparatus I according to the present embodiment performs printing by causing the ink deflected by the deflection electrode 15 to land on the printing target object.

Specifically, the print head 1 includes a housing 10 that accommodates the pressurizer 11, the nozzle 12, the charging electrode 13, the charge detection sensor 14, the deflection electrode 15, the gutter 16, the gutter sensor 16b, the cleaning nozzle 17, the high-voltage generation unit 18, and the storage unit 19 therein and defines a flying space S1 of the ink particles. The print head 1 can eject the ink particles deflected by the deflection electrode 15 to the outside of the housing 10 through the flying space S1.

As exemplified in FIG. 3, the housing 10 extends in the up-down direction on the drawing sheet. In the following description, the longitudinal direction of the housing 10 is simply referred to as an "up-down direction", while two directions orthogonal to the up-down direction are referred to as a "front-rear direction" and a "left-right direction", respectively. In other drawings, directions corresponding to these directions are referred to as an “up-down direction", a "front-rear direction", and a "left-right direction", respectively.

Here, "upper" refers to the upper side of the drawing sheet of FIG. 3, and "lower" refers to the lower side of the drawing sheet. Similarly, "front" refers to the front side (specifically, the left front side) of the drawing sheet of FIG. 3, "rear" refers to the back side (specifically, the right back side) of the drawing sheet, "left" refers to the left side (specifically, the upper left side) of the drawing sheet, and "right" refers to the right side "specifically, the lower right side" of the drawing sheet. In other drawings, those corresponding to these are referred to as "upper", "lower", "front", "rear", "left", and "right", respectively.

Note that the print head 1 does not necessarily have its up-down direction along the vertical direction (gravity direction). The print head 1 may also be in a posture with its up-down direction along the horizontal direction.

Further, the print head 1 has an ink ejection port 10a for ejecting the ink deflected by the deflection electrode 15 to the outside. As illustrated in FIG. 3, the ink ejection port 10a opens on the lower surface of the housing 10 forming the outer shape of the print head 1. Hereinafter, the ink ejection port 10a is also simply referred to as an ejection port 10a. The ink particles are ejected from the ejection port 10a toward the lower side of the housing 10.

As illustrated in FIG. 1, the print head 1 at the time of printing is supported by, for example, the support member 2. The print head 1 in a state of being supported by the support member 2 is arranged such that the ejection port 10a faces the print surface of the print object W from the upward direction. This place is an example of an installation place of the print head 1 when printing is performed by the inkjet recording apparatus I.

Hereinafter, each unit constituting the print head 1 will be described in order. In the following description, the "up-down direction" refers to a direction along the vertical direction. For example, the upper side of the drawing sheet of FIG. 3 corresponds to the "upward direction", and the lower side of the ground in FIG. 3 corresponds to the "downward direction".

### (Pressurizer 11)

As exemplified in FIG. 3, the pressurizer 11 is arranged near an upper end of the housing 10 in the flight space S1. The pressurizer 11 is configured to be supplied with printing ink from the ink tank 106 via the connection cable 107.

The pressurizer 11 pressurizes the ink liquid supplied from the ink tank 106. The ink pressurized by the pressurizer 11 is supplied to the nozzle 12. Although not illustrated, the pressurizer 11 according to the present embodiment is grounded.

### (Nozzle 12)

The nozzle 12 is connected to a lower end of the pressurizer 11, and is arranged in a posture in which an opening end (printing ink) thereof faces downward. The nozzle 12 includes a piezoelectric element (for example, a piezo element) that applies vertical vibration to the ink, and applies the vertical vibration to the ink pressurized by the pressurizer 11 and then ejects the ink from the ejection port (opening end). Due to this vibration, the ink liquid ejected from the nozzle 12 is formed into particles after a predetermined time from the ejection timing.

Here, the printing ink ejected from the nozzle 12 without being applied vibration (without being vibrated) flows in a so-called "ink shaft" of a shaft shape. On the other hand, the printing ink ejected from the nozzle 12 to which vibration has been applied (which has been vibrated) has a shaft shape immediately after being ejected from the nozzle 12, but becomes a particle shape as being separated from the nozzle 12. The particle-formed printing ink is so-called "ink particles". The printing ink passes through the charging electrode 13 regardless of whether it is an ink shaft or ink particles.

When the nozzle 12 includes a piezoelectric element, particle formation of the ink can be controlled through a voltage (piezoelectric voltage) applied to the piezoelectric element. In the present embodiment, the controller 100 is configured to apply a controllable piezoelectric voltage to the piezoelectric element of the nozzle 12.

Note that the solvent supplied to clean the inside of the print head 1 sequentially passes through the pressurizer 11 and the nozzle 12 and is ejected from the distal end of the nozzle 12. The solvent thus ejected flows axially and passes through the charging electrode 13.

Furthermore, a suction path 47 illustrated in FIG. 4 is connected to the nozzle 12, for example, as a return path for releasing the pressure inside the print head 1 at the time of power-down of the inkjet recording apparatus I. The solvent can also be sucked from the nozzle 12 through the suction path 47.

### (Charging Electrode 13)

As exemplified in FIG. 3, the charging electrode 13 includes a pair of metal plates having electrical conductivity, and is arranged below the nozzle 12. Here, the pair of metal plates constituting the charging electrode 13 is fixed to the housing 10 in a posture in which the longitudinal directions thereof are aligned with the up-down direction and in a posture in which the metal plates face each other in the horizontal direction. The interval between the pair of metal plates is set to be larger than the particle diameter of the ink ejected from the nozzle 12, and the printing ink ejected from the nozzle 12 passes between the pair of metal plates. Note that the metal plates constituting the charging electrode 13 need not be a pair.

A potential (positive potential) is applied to the charging electrode 13 at least when a printing operation is executed. As a result, a potential difference is generated between the pressurizer 11 and the charging electrode 13, and the ink particles passing through the charging electrode 13 can be charged. In order to charge each ink particle, the charging electrode 13 according to the present embodiment is arranged in the vicinity of a breakpoint where the printing ink ejected from the nozzle 12 is formed into particles.

Specifically, a pulse potential that can be controlled by the controller 100 is applied to the charging electrode 13. Here, when a relatively high voltage is applied to the charging electrode 13, the charge amount (magnitude of negative charge) of each ink particle becomes larger than when a lower voltage is applied. When the charge amount of each ink particle is large, the ink particle is greatly deflected by the deflection electrode 15 as compared with when the charge amount is small. The controller 100 can control the deflection amount of the ink particles by adjusting the magnitude of the pulse potential. The ink particles charged by the charging electrode 13 pass by the side of the charge detection sensor 14 and reach the deflection electrode 15.

In addition, the solvent ejected from the nozzle 12 passes through the side of the charge detection sensor 14 and reaches the deflection electrode 15 without being charged.

As illustrated in FIG. 2B, the charging electrode 13 is electrically connected to the control unit 101. The charging electrode 13 generates a potential difference for charging the ink particles by receiving an electric signal (the pulse potential described above) from the control unit 101. The magnitude (voltage value) of the pulse potential input from the control unit 101 to the charging electrode 13 is, for example, a high voltage within a range of 200 V or more and 400 V or less.

### (Charge Detection Sensor 14)

As exemplified in FIG. 3, the charge detection sensor 14 is arranged below the charging electrode 13. Specifically, the charge detection sensor 14 is arranged below a metal plate (in the illustrated example, the metal plate on the right side of the drawing sheet) constituting the charging electrode 13 so as not to cross the locus when the ink particles fly. By arranging the charge detection sensor 14 in this manner, it is possible to avoid collision between the ink particles and the charge detection sensor 14.

In addition, the charge detection sensor 14 according to the present embodiment is connected to a circuit board provided inside the housing 10. The charge detection sensor 14 can detect the charged state (in particular, the charge amount of each ink particle) of the ink particles passing through the side. A detection result by the charge detection sensor 14 is output to the control unit 101 as a detection signal. Based on this detection signal, the control unit 101 can determine whether or not each ink particle is appropriately charged.

### (Deflection Electrode 15)

As exemplified in FIG. 3, the deflection electrode 15 includes a pair of metal plates (so-called "counter electrodes") having electrical conductivity, and is arranged below the charging electrode 13 and the charge detection sensor 14. Here, the pair of metal plates is fixed to the housing 10 in a posture in which the longitudinal directions thereof are substantially along the up-down direction and in a posture in which the pair of metal plates face each other in the horizontal direction. The ink particles that have passed between the pair of metal plates constituting the charging electrode 13 pass between the pair of metal plates constituting the deflection electrode 15.

A voltage (hereinafter, this is also referred to as "deflection voltage") that can be controlled by the controller 100 is applied to the deflection electrode 15. As a result, a potential difference corresponding to the deflection voltage is generated between the pair of metal plates constituting the deflection electrode 15. Due to this potential difference, the flying direction of the ink particles can be deflected according to the charge amount of the ink particles. The flying direction of the ink particles can be deflected along the arrangement direction of the pair of metal plates constituting the deflection electrode 15.

That is, the flying direction of the ink particles can be controlled via the deflection voltage applied to each of the charging electrode 13 and the deflection electrode 15. The ink particles whose flying direction is controlled in this manner include those deflected by the deflection electrode 15 and those not deflected by the deflection electrode 15 (those not deflected). Among them, the ink particles deflected by the deflection electrode 15 are involved in printing of the printing target object W. The ink particles deflected by the deflection electrode 15 are ejected from the ejection port 10a provided on the lower surface of the housing 10, and land on the printing target object W.

On the other hand, the ink particles that are not deflected by the deflection electrode 15 are not involved in the printing of the print object W. Such ink particles, or the shaft-shaped printing ink that is not formed into particles in the first place, reach the inside of the gutter 16 as exemplified by the chain line in FIG. 3. Similarly, the solvent used for cleaning the nozzles 12 and the like in the print head 1 and having passed through the deflection electrode 15 also reaches the inside of the gutter 16.

Specifically, the deflection electrode 15 according to the present embodiment includes first and second electrode plates 151 and 152 facing each other. The first electrode plate 151 is grounded. The first electrode plate 151 can also be referred to as a ground electrode.

### (Gutter 16)

As exemplified in FIG. 3, the gutter 16 is configured by a curved pipe having an opening 16a facing upward, and is arranged below the deflection electrode 15. The gutter 16 according to the present embodiment can collect the printing ink that is not involved in printing of the print object W and the solvent (specifically, the solvent ejected from the nozzle 12) that has passed through the nozzle 12.

Specifically, in the present embodiment, the opening 16a of the gutter 16 and the opening end of the nozzle 12 are arranged to face each other, and the opening end of the nozzle 12 is located directly above the opening 16a of the gutter 16. With this arrangement, the fluid flowing along the vertical direction from the opening end of the nozzle 12 and the flying fluid can be received from the opening 16a of the gutter 16.

The gutter 16 is provided with a charge type or thermistor type gutter sensor 16b (see FIG. 3). The gutter sensor 16b can detect whether the printing ink is in the gutter 16, determine that the adjustment of the ink shaft is completed if the printing ink is in the gutter 16, and determine that the adjustment of the ink shaft is not completed if the printing ink is not in the gutter 16. The gutter sensor 16b is connected to the control unit 101 of the controller 100 and is configured to output a signal to the control unit 101.

The printing ink or solvent collected by the gutter 16 is sent back to the controller 100 through the ink supply pipe 44, the solvent supply pipe 54, and the like, and stored in the ink tank 106.

The printing ink or solvent collected by the gutter 16 is sent back to the controller 100 through the ink supply pipe 44, the solvent supply pipe 54, and the like, and stored in the ink tank 106.

### (Cleaning Nozzle 17)

As exemplified in FIG. 3, the cleaning nozzle 17 is provided in the print head 1. The cleaning nozzle 17 functions as a so-called solvent spray unit. The cleaning nozzle 17 is a nozzle for cleaning the nozzle 12, the charging electrode 13, the deflection electrode 15, and the like in the print head 1 by spraying a solvent thereto and can eject a solvent as a cleaning liquid. The solvent sprayed from the cleaning nozzle 17 is supplied from the solvent supply unit 105, for example, the solvent cartridge 51.

### (High-Voltage Generation Unit 18)

The high-voltage generation unit 18 generates a high voltage to be applied to the deflection electrode 15. Specifically, the high-voltage generation unit 18 according to the present embodiment is electrically connected to the second electrode plate 152. As illustrated in FIG. 2B, high-voltage generation unit 18 is electrically connected to control unit 101. The high-voltage generation unit 18 generates a high voltage on the basis of an electric signal input from the control unit 101. The magnitude (voltage value) of the electric signal input from the control unit 101 to the high-voltage generation unit 18 is at least lower than the magnitude (voltage value) of the electric signal input from the control unit 101 to the charging electrode 13.

When the high-voltage generation unit 18 applies a high voltage to the second electrode plate 152, a potential difference is generated between the first electrode plate 151 and the second electrode plate 152. The magnitude of the high voltage applied by the high-voltage generation unit 18 may be determined within a range of 3 kV or more and 11 V or less, specifically within a range of 5 kV or more and 9 kV or less, and more specifically within a range of 6 kV or more and 8 kV or less.

### (Storage Unit 19)

The storage unit 19 stores at least one of information indicating the ink type, information regarding the life of the inkjet recording apparatus I, and correction information for adjusting the high voltage by the high-voltage generation unit 18. The storage unit 19 is configured by a nonvolatile memory such as a so-called flash memory. A specific example of the content stored in the storage unit 19 will be described later.

### (Other Feature Points)

As another feature, as illustrated in FIGS. 1, 2A, 2B, and 3, the print head 1 according to the present embodiment is configured by assembling a head main body 1A to which a connection cable 107 is connected and a head module 1B that is mountable on and dismountable from the head main body 1A.

The configurations and structures of the head main body 1A and the head module 1B are closely related to the ink supply from the ink supply unit 104 to the print head 1. Therefore, before describing the head main body 1A and the head module 1B in detail, a configuration related to a flow path of ink and a solvent in the inkjet recording apparatus I, specifically, a configuration related to the ink supply pipe 44 and the solvent supply pipe 54 will be described with reference to FIG. 4.

### <Regarding Flow Path of Ink and Solvent>

As described above, the ink supply pipe 44 supplies the ink from the ink cartridge 41 to the ink tank 106, and supplies the printing ink from the ink tank 106 to the print head 1. Meanwhile, the solvent supply pipe 54 supplies the solvent from the solvent cartridge 51 to each of the print head 1 and the ink tank 106.

### -First Path R1-

The ink supply pipe 44 constitutes, for example, a path (first path R1) for feeding ink (ink before concentration adjustment) from the ink cartridge 41 to the ink tank 106.

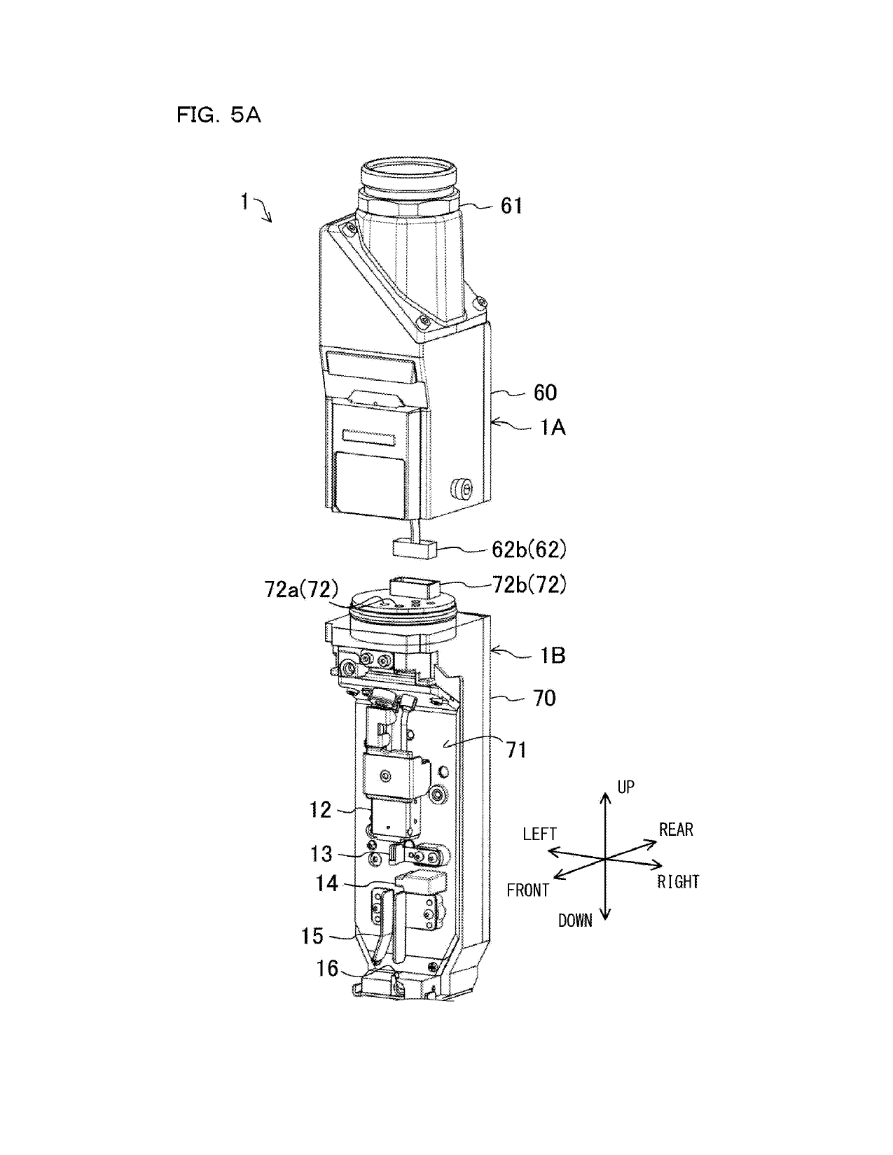

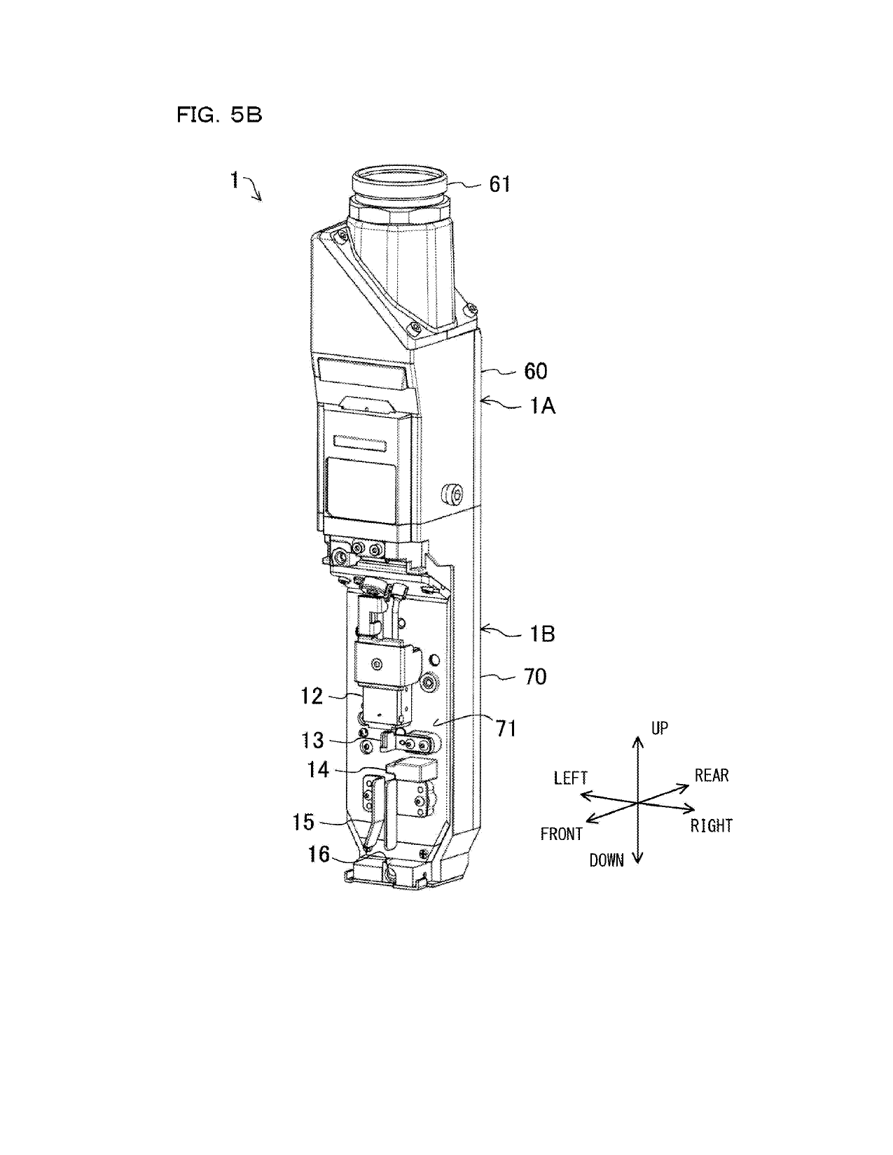

As illustrated in FIG. 5, the first path R1 according to the present embodiment includes a first ink pipe 44a as an ink circulation pipe, a second ink pipe 44b, and a third ink pipe 44c. The first ink pipe 44a, the second ink pipe 44b, and the third ink pipe 44c are all arranged in the controller 100 in the present embodiment.

The first ink pipe 44a has one end connected to the hollow needle 43 and the other end (see a branch portion B1 in FIG. 5) branching into the second ink pipe 44b and the third ink pipe 44c. The first ink pipe 44a as an ink circulation pipe connects the ink hollow needle 43 and the ink tank 106 via the second ink pipe 44b and the third ink pipe 44c, and circulates the ink from the ink hollow needle 43 to the ink tank 106. In the present embodiment, the ink is introduced into the ink tank 106 through the third ink pipe 44c, but may be introduced through, for example, the second ink pipe 44b. In this case, the ink is introduced into the ink tank 106 without passing through a viscometer 46.

The classifications of the first ink pipe 44a, the second ink pipe 44b, and the third ink pipe 44c are merely for convenience. For example, the first ink pipe 44a and the second ink pipe 44b may be regarded as one ink circulation pipe. In this case, the ink circulation pipe constituted by the first ink pipe 44a and the second ink pipe 44b directly connects the ink hollow needle 43 and the ink tank 106.

The first pump P1 is arranged in the middle of the first ink pipe 44a. The first pump P1 is a suction pump for sucking so as to generate a flow from the ink hollow needle 43 toward the first ink pipe 44a.

A merging portion 45 is arranged in the first ink pipe 44a between the ink hollow needle 43 and the first pump P1. The merging portion 45 is configured to join the solvent or the ink in the first ink pipe 44a. In particular, the merging portion 45 exemplified in FIG. 5 is connected to a third solvent pipe 54c of the solvent supply pipe 54 and is configured to merge the solvent of the solvent and the ink with respect to the ink flowing through the first ink pipe 44a. The ink to be merged in the first ink pipe 44a may be a printing ink.

The eighth valve V8 is arranged in the first ink pipe 44a between the merging portion 45 and the first pump P1. The eighth valve V8 is an on-off valve that opens and closes the flow path of the first ink pipe 44a.

The second ink pipe 44b connects the other end (branch portion B1) of the first ink pipe 44a and the ink tank 106. The first valve V1 is arranged in the middle of the second ink pipe 44b. The first valve V1 is an on-off valve that opens and closes the flow path of the second ink pipe 44b.

The third ink pipe 44c connects the other end (branch portion B1) of the first ink pipe 44a and the ink tank 106. The 11th valve V11 is arranged in the middle of the third ink pipe 44c. The 11th valve V11 is an on-off valve that opens and closes the flow path of the third ink pipe 44c.

The viscometer 46 is arranged in the third ink pipe 44c between the 11th valve V11 and the ink tank 106. The viscometer 46 detects the flow rate of the ink or the printing ink flowing through the third ink pipe 44c, and measures the viscosity based on the flow rate. The viscometer 46 inputs a detection signals corresponding to the measurement result to the control unit 101. In the present embodiment, the viscometer 46 having the principle of detecting the ink flow rate is used, but the present invention is not limited thereto, and for example, the viscometer 46 that repeats the filling and discharge of the ink and measures the viscosity based on the time at the time of ink discharge may be used.

The ink from the ink cartridge 41 sequentially passes through the ink hollow needle 43, the ink reservoir 42, the first ink pipe 44a, the second ink pipe 44b, and the third ink pipe 44c based on the operation status of the first pump P1 and the opening/closing statuses of the first valve V1, the fifth valve V5, and the eighth valve V8, and is supplied to the ink tank 106.

### -Second Path R2-

Meanwhile, the solvent supply pipe 54 constitutes a path (second path R2) for feeding the solvent from the solvent cartridge 51 to the ink tank 106 together with some elements of the ink supply pipe 44.

As illustrated in FIG. 5, the second path R2 according to the present embodiment includes the first solvent pipe 54a of the solvent supply pipe 54, a part of the first ink pipe 44a (a portion from the connection portion B2 to the branch portion B1 in FIG. 5), and all of the second ink pipe 44b and the third ink pipe 44c. In the present embodiment, the first solvent pipe 54a is arranged in the controller 100.

As described above, the names of the ink supply pipe 44 and the solvent supply pipe 54 are given focusing on a side surface of a part of each circulation pipe, and are merely for convenience. As in the first ink pipe 44a, the second ink pipe 44b, and the third ink pipe 44c, both ink circulation and solvent circulation may be achieved. Each circulation pipe may contribute to the configuration of one or more paths.

The first solvent pipe 54a has one end connected to the ink hollow needle 43 and the other end (connecting portion B2) connected to the first ink pipe 44a. A 13th valve V13 is arranged in the middle of the first solvent pipe 54a in the solvent supply pipe 54. The 13th valve V13 is an on-off valve that opens and closes the flow path of the first solvent pipe 54a.

The solvent from the solvent cartridge 51 sequentially passes through the solvent hollow needle 53, the solvent reservoir 52, and the first solvent pipe 54a according to the operating status of the first pump P1 and the opening/closing status of the 13th valve V13, and is supplied to a middle portion of the first ink pipe 44a (see the connecting portion B2 in FIG. 5). The solvent supplied to this portion sequentially passes through the first ink pipe 44a, the second ink pipe 44b, and the third ink pipe 44c according to the opening/closing statuses of the first valve V1 and the 11th valve V11, and is supplied to the ink tank 106.

The concentration of the ink supplied through the first path R1 is adjusted by the solvent supplied through the second path R2. Thus, the printing ink is stored in the ink tank 106.

### -Third Path R3-

Returning to the description of the ink supply pipe 44, the ink supply pipe 44 also constitutes a path (third path R3) for circulating and stirring the stored object (printing ink) in the ink tank 106 in the controller 100.

As illustrated in FIG. 5, the third path R3 according to the present embodiment includes the fourth ink pipe 44d and the fifth ink pipe 44e of the ink supply pipe 44, a part of the first ink pipe 44a (a portion from the connection portion B2 to the branch portion B1 in FIG. 5), and all of the second ink pipe 44b and the third ink pipe 44c. The fourth ink pipe 44d and the fifth ink pipe 44e are both arranged in the controller 100 in the present embodiment.

The fourth ink pipe 44d has one end connected to the ink tank 106 and the other end (connecting portion B2) connected to the first ink pipe 44a. A ninth valve V9 is arranged in the middle of the fourth ink pipe 44d. The ninth valve V9 is an on-off valve that opens and closes the flow path of the fourth ink pipe 44d.

The fifth ink pipe 44e has one end connected to the ink tank 106 and the other end (connecting portion B2) connected to the first ink pipe 44a. The fifth valve V5 is arranged in the middle of the fifth ink pipe 44e. The fifth valve V5 is an on-off valve that opens and closes the flow path of the fifth ink pipe 44e.

The connection position between the fourth ink pipe 44d and the ink tank 106 (the position where the printing ink is sucked by the fourth ink pipe 44d) is higher than the connection position between the fifth ink pipe 44e and the ink tank 106 (the position where the printing ink is sucked by the fifth ink pipe 44e) in the height direction of the ink tank 106.

The printing ink in the ink tank 106 is sucked out by the fourth ink pipe 44d or the fifth ink pipe 44e based on the operation status of the first pump P1 and the opening/closing statuses of the first valve V1, the fifth valve V5, the ninth valve V9, and the 11 valve V11, and then sequentially passes through a part of the first ink pipe 44a (a portion from the connection portion B2 to the branch portion B1 in FIG. 5), the second ink pipe 44b, and the third ink pipe 44c, and is sent back to the ink tank 106. As a result, the printing ink circulates in the controller 100.

Furthermore, the printing ink can be stirred in the ink tank 106 by not only simply circulating in the controller 100 but also sucking out the printing ink from two places having different heights. Thus, the density of the printing ink can be made uniform (the dispersion state of the pigment can be maintained). This configuration is particularly effective when the pigment ink is used for the ink.

### -Fourth Path R4-

The ink supply pipe 44 further forms a path (fourth path R4) for feeding the printing ink from the ink tank 106 to the nozzle 12 and feeding the printing ink back from the gutter 16 to the ink tank 106.

As illustrated in FIG. 5, the fourth path R4 according to the present embodiment is configured by the sixth ink pipe 44f and the seventh ink pipe 44g of the ink supply pipe 44. The sixth ink pipe 44f and the seventh ink pipe 44g both connect the controller 100 and the print head 1.

The sixth ink pipe 44f has one end connected to the ink tank 106 and the other end connected to the nozzle 12. The third pump P3 is arranged in the middle of the sixth ink pipe 44f. The third pump P3 is a suction pump for sucking so as to generate a flow from the ink tank 106 toward the sixth ink pipe 44f.

A 14th valve V14 is arranged in the sixth ink pipe 44f between the third pump P3 and the nozzle 12. The 14th valve V14 is an on-off valve that opens and closes the flow path of the sixth ink pipe 44f.

The seventh ink pipe 44g has one end connected to the gutter 16 and the other end connected to the ink tank 106. A fourth pump P4 is arranged in the middle of the seventh ink pipe 44g. The fourth pump P4 is a suction pump for sucking so as to generate a flow from the gutter 16 toward the seventh ink pipe 44g.

A tenth valve V10 is arranged in the seventh ink pipe 44g between the gutter 16 and the fourth pump P4. The tenth valve V10 is an on-off valve that opens and closes the flow path of the seventh ink pipe 44g.

The printing ink in the ink tank 106 is sucked out by the sixth ink pipe 44f according to the operating status of the third pump P3 and the opening/closing status of the 14th valve V14, and ejected from the nozzle 12. The printing ink ejected from the nozzle 12 lands on the surface of the print object W during printing and is collected by the gutter 16 during non-printing. The latter printing ink is sucked out by the seventh ink pipe 44g according to the operation status of the fourth pump P4 and the opening/closing status of the tenth valve V10, and sent back to the ink tank 106. As a result, the printing ink circulates between the controller 100 and the print head 1.

### -Fifth Path R5-

Meanwhile, the solvent supply pipe 54 constitutes a path (fifth path R5) for feeding a cleaning solvent from the solvent cartridge 51 to the nozzle 12 together with some elements of the ink supply pipe 44.

As illustrated in FIG. 5, the fifth path R5 according to the present embodiment is configured by a part of the first solvent pipe 54a (upstream end including the connection portion with the solvent hollow needle 53) and the second solvent pipe 54b in the solvent supply pipe 54, and a part of the sixth ink pipe 44f (downstream end including the connection portion with the nozzle 12). The second solvent pipe 54b connects the controller 100 and the print head 1.

The second solvent pipe 54b has one end connected to the first solvent pipe 54a between the solvent hollow needle 53 and the 13th valve V13, and the other end connected to the sixth ink pipe 44f between the 14th valve V14 and the nozzle 12. The second pump P2 is arranged in the middle of the second solvent pipe 54b in the solvent supply pipe 54. The second pump P2 is a suction pump for sucking so as to generate a flow from the solvent hollow needle 53 toward the solvent supply pipe 54 (particularly, the second solvent pipe 54b).

The 12th valve V12 is arranged in the second solvent pipe 54b between the second pump P2 and the nozzle 12. The 12th valve V12 is an on-off valve that opens and closes the flow path of the second solvent pipe 54b in the solvent supply pipe 54.

The solvent from the solvent cartridge 51 sequentially passes through the solvent hollow needle 53, the solvent reservoir 52, the first solvent pipe 54a, and the second solvent pipe 54b according to the operating status of the second pump P2 and the opening/closing status of the 12th valve V12, and is supplied to a middle portion of the sixth ink pipe 44f (a portion between the 14th valve V14 and the nozzle 12). The solvent supplied to this portion is ejected from the nozzle 12. This solvent cleans the print head 1.

The cleaning nozzle 17 is connected to the second solvent pipe 54b. As described above, the cleaning nozzle 17 can spray a solvent as a cleaning liquid. On the way from the cleaning nozzle 17 to the second solvent pipe 54b, a 15th valve V15 for controlling the supply of the solvent to the cleaning nozzle 17 is provided.

### -Sixth Path R6-

The solvent supply pipe 54 further constitutes a path (sixth path R6) for feeding the solvent from the solvent cartridge 51 to the ink supply pipe 44 and the ink hollow needle 43 via the merging portion 45.

As illustrated in FIG. 5, the sixth route R6 according to the present embodiment includes a part of the first solvent pipe 54a, a part of the second solvent pipe 54b, and the third solvent pipe 54c in the solvent supply pipe 54. The "part of the first solvent pipe 54a" herein refers to a portion from the solvent hollow needle 53 to a connecting portion B3 of the first solvent pipe 54a and the second solvent pipe 54b. The "part of the second solvent pipe 54b" as used herein refers to a portion from the connecting portion B3 of the first solvent pipe 54a and the second solvent pipe 54b to a position between the second pump P2 and the 12th valve V12 (see a connecting portion B4 in FIG. 5). The sixth route R6 branches from the fifth route R5 on the downstream side of the second pump P2. The third solvent pipe 54c is arranged in the controller 100 in the present embodiment.

The third solvent pipe 54c has one end connected to the second solvent pipe 54b between the second pump P2 and the 12th valve V12, and the other end connected to the merging portion 45.

The third solvent pipe 54c constitutes a "solvent circulation pipe" in the present embodiment together with the part of the first solvent pipe 54a and the part of the second solvent pipe 54b. When the solvent reservoir 52 receives the solvent cartridge 51, the third solvent pipe 54c causes the solvent in the solvent cartridge 51 to flow to the merging portion 45 via the first solvent pipe 54a and the second solvent pipe 54b.

Here, the second pump P2 described above is arranged in the middle of the second solvent pipe 54b constituting the solvent circulation pipe. The second pump P2 can also be regarded as a solvent pump that operates to generate a flow from the second solvent pipe 54b toward the ink hollow needle 43 through the merging portion 45 and the first ink pipe 44a.

The 18th valve V18 is arranged in the second solvent pipe 54b between the merging portion 45 and the second pump P2. The 18th valve V18 is a second on-off valve that opens and closes the flow path of the second solvent pipe 54b.

-Path Related to Suction of Ink -

The controller 100 also has a path associated with suction of ink. For example, the controller 100 has the suction path 47 connected to the nozzle 12. The suction path 47 is provided with a sixth valve V6. For example, at the time of non-printing, by operating the first pump P1 in a state where the sixth valve V6 is opened, the ink can be sucked via the suction path 47 and the sucked ink can be sent back to the controller 100.

### <Detailed Structure of Print Head 1>

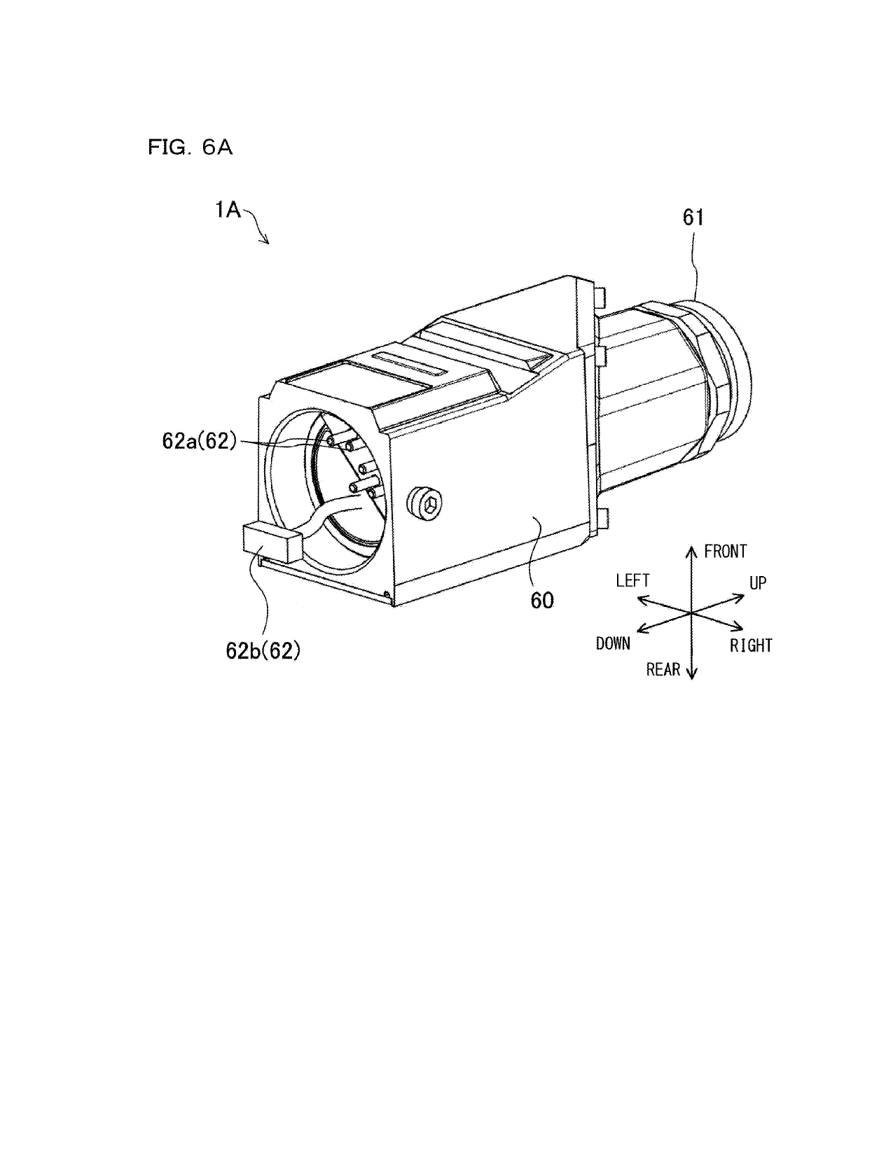

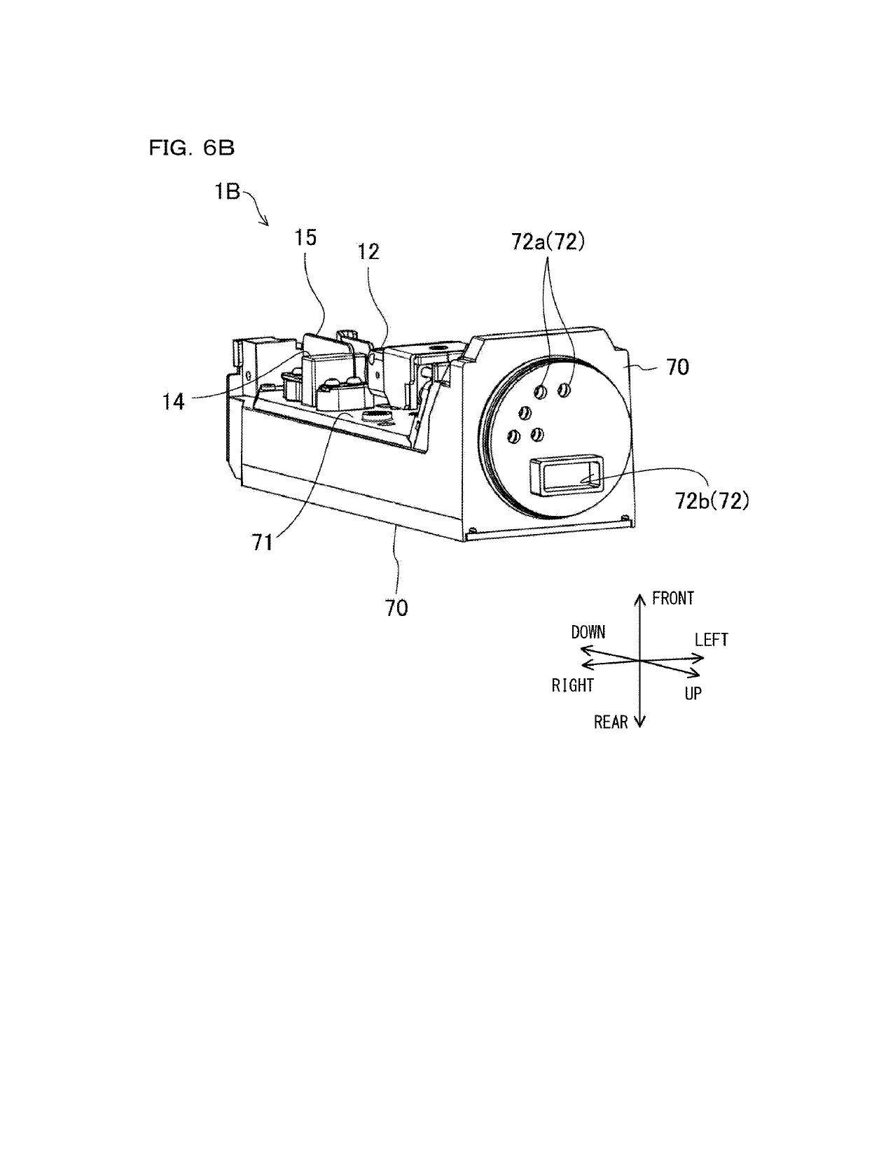

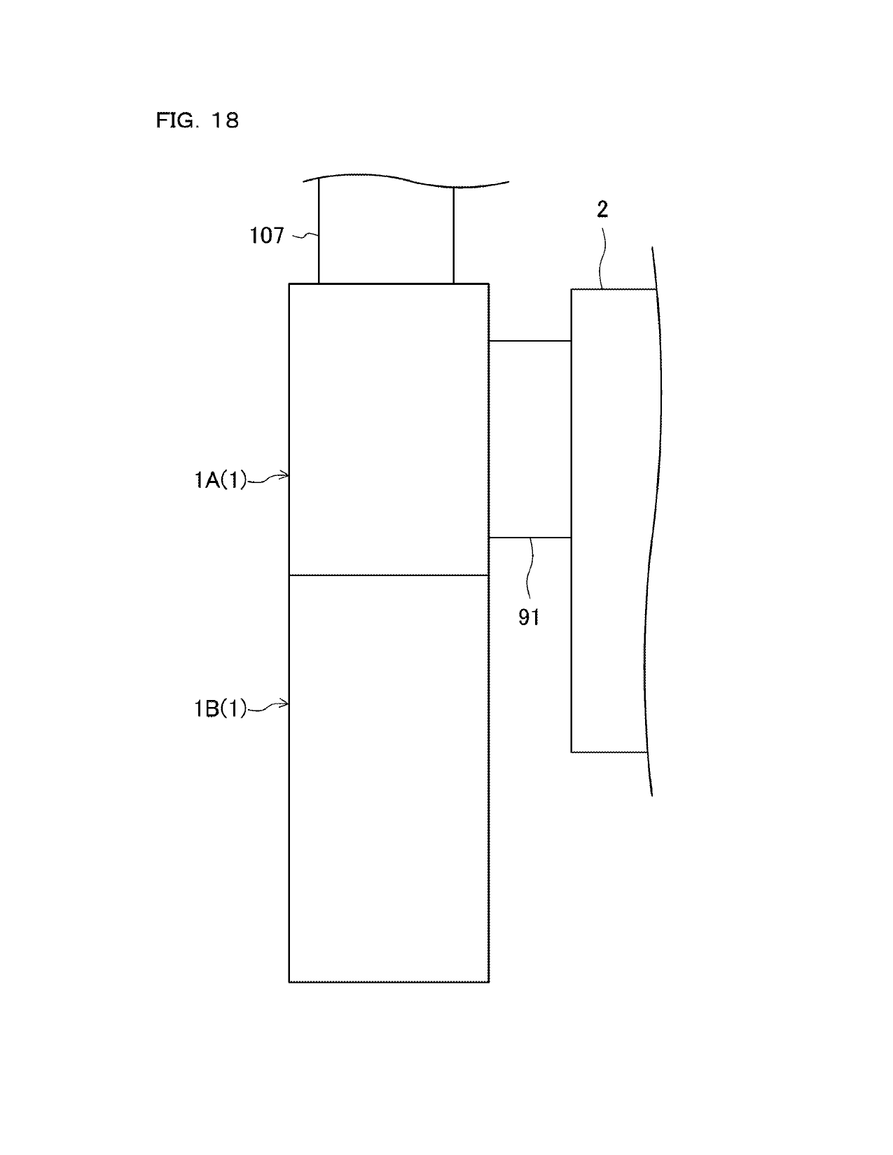

FIG. 5A is an exploded perspective view illustrating the configuration of the head main body 1A and the head module 1B, and FIG. 5B is a perspective view illustrating the print head 1 after assembly. FIG. 6A is a perspective view illustrating a structure of a first engagement portion 10b of the head main body 1A, and FIG. 6B is a perspective view illustrating a structure of a second engagement portion 10c of the head module 1B. FIG. 18 is a diagram illustrating an attachment portion 91 in the present embodiment.

As illustrated in FIGS. 2B and 3, the print head 1 includes the head main body 1A to which the connection cable 107 is connected, and the head module 1B that is mountable on and dismountable from the head main body 1A. The head main body 1A supplies ink or a solvent to the nozzle 12 via the connection cable 107. The head module 1B accommodates the nozzle 12, the charging electrode 13, the deflection electrode 15, and the gutter 16. The print head 1 is assembled by mounting the head module 1B to the head main body 1A. Note that, for the relationship between the print head 1 and the head module 1B, also refer to the hatched portion in FIG. 4.

As illustrated in FIG. 18, the connection cable 107, the head main body 1A, and the head module 1B are connected in this order from the top. Here, the attachment portion 91 for positioning and fixing the print head 1 is connected to the head main body 1A. The print head 1 is connected to the support member 2 via the attachment portion 91. Specifically, in the present embodiment, the attachment portion 91 extending in the up-down direction is connected to a rear surface of the head main body 1A (a rear surface of a first housing portion 60 to be described later).

In addition, the print head 1 includes the high-voltage generation unit 18, the storage unit 19, a first sensor 21, a second sensor 22, a first magnet 23, and a second magnet 24 as elements related to the assembly structure as described above. Hereinafter, the head main body 1A and the head module 1B will be described in detail, and elements related to these assembly structures will also be described.

### (Head Main Body 1A)

As illustrated in FIGS. 1 and 3, the head main body 1A is a component to which the connection cable 107 is connected. The head main body 1A may be referred to as a "base end" in the print head 1 or a "support" that supports the head module 1B against gravity. The head main body 1A is located between the head module 1B and the connection cable 107, and can also be referred to as a "relay portion" that supplies ink or a solvent to the head module 1B via the connection cable 107.

Specifically, the head main body 1A according to the present embodiment includes the first housing portion 60, a cable connection portion 61, and a first engagement portion 62.

### -First Housing Portion 60-

The first housing portion 60 has a shape extending in the up-down direction, for example, a rectangular tube shape. The first housing portion 60 constitutes the housing 10 of the entire print head 1 together with a second housing portion 70 of the head module 1B.

As illustrated in FIG. 3, the ink supply path (ink supply pipe 44), the solvent supply path (solvent supply pipe 54), the 12th valve V12 and the 14th valve V14, the first sensor 21, and the second sensor 22 are accommodated in the first housing portion 60.

In a state where the head module 1B is mounted on the head main body 1A, the ink supply pipe 44 and the nozzle 12 are fluidly connected. The ink supply pipe 44 is opened and closed by, for example, the 14th valve V14. As illustrated in FIGS. 2B and 3, the 14th valve V14 is located not in the head module 1B but in the head main body 1A.

In this manner, the head main body 1A is provided with the valve (14th valve V14) that opens and closes a flow path for flowing ink between the head main body 1A and the head module 1B. In particular, in the present embodiment, the head main body 1A is provided with the valve (14th valve V14) that opens and closes an ink supply path to the nozzle 12. It is not essential to provide the 14th valve V14 in the head main body 1A.

Similarly, in a state where the head module 1B is mounted on the head main body 1A, the solvent supply path (solvent supply pipe 54) and the nozzle 12 are fluidly connected. A solvent supply pipe 54d is opened and closed by, for example, the 12th valve V12. As illustrated in FIGS. 2B and 3, the 14th valve V14 is located not in the head module 1B but in the head main body 1A.

In other words, in the present embodiment, the head main body 1A is provided with the valve (12th valve V12) that opens and closes a solvent supply path to the nozzle 12. It is not essential to provide the 12th valve V12 in the head main body 1A.

As illustrated in FIG. 2B, the 12th valve V12 and the 14th valve V14 are electrically connected to the control unit 101. The 12th valve V12 and the 14th valve V14 transition from a closed state to an open state by receiving a control signal from the control unit 101. The 12th valve V12 and the 14th valve V14 transition from the open state to the closed state by receiving a control signal from the control unit 101.

The first sensor 21 is a sensor that detects removal of the head module 1B from the head main body 1A. In the present embodiment, the first sensor 21 is constituted by a Hall element. The first sensor 21 is electrically connected to the control unit 101, and inputs a detection signal to the control unit 101.

As illustrated in FIG. 3, the first sensor 21 including a Hall element is located at the lower end of the head main body 1A. In a state where the head module 1B is mounted on the head main body 1A, the first sensor 21 is located so as to be aligned with the first magnet 23 of the head module 1B in the up-down direction.

Similarly to the first sensor 21, the second sensor 22 is a sensor that detects removal of the head module 1B from the head main body 1A. In the present embodiment, the first sensor 21 is constituted by a Hall element. The second sensor 22 is electrically connected to the control unit 101, and inputs a detection signal to the control unit 101.

As illustrated in FIG. 3, the second sensor 22 including a Hall element is located at the lower end of the head main body 1A. In a state where the head module 1B is mounted on the head main body 1A, the second sensor 22 is located so as to be aligned with the second magnet 24 of the head module 1B in the up-down direction.

As illustrated in FIG. 2B, the first sensor 21 and the second sensor 22 are configured such that at least some electric paths are independent from each other. The term "electric path" as used herein means a path constituted by electric wiring. In the example illustrated in FIG. 3, a first electric path 21a and a second electric path 22a are independent from each other. With this configuration, even if one of the first electric path 21a and the second electric path 22a is disconnected, the detection signal can be input to the control unit 101 through the other path.

It is not essential to provide the first sensor 21 and the second sensor 22 in the head main body 1A. At least one of the first sensor 21 and the second sensor 22 may be provided in the head module 1B.

### -Cable Connection Portion 61-

As illustrated in FIG. 5A, the cable connection portion 61 is located at the upper end of the head main body 1A. The cable connection portion 61 has a tubular shape opened upward, for example, a cylindrical shape. One end of the connection cable 107 is connected to the cable connection portion 61.

By connecting the connection cable 107 to the cable connection portion 61, the controller 100 and the print head 1 are fluidly and electrically connected. This enables ink and a solvent to be supplied to the print head 1, and power to be supplied from the controller 100 to the print head 1.

### -First Engagement Portion 62-

As illustrated in FIG. 6A, the first engagement portion 62 is located at the lower end of the head main body 1A. The first engagement portion 62 engages with a second engagement portion 72 of the head module 1B when the head module 1B is mounted on the head main body 1A. The engagement herein may be read as "fitting".

Specifically, the first engagement portion 62 according to the present embodiment has a convex shape protruding downward from the lower end of the first housing portion 60. Specifically, the first engagement portion 62 has a cylindrical shape protruding downward from the lower surface of the first housing portion 60.

A first fluid connection portion 62a and a first electrical connection portion 62b are located on the lower surface of the first engagement portion 62. The first fluid connection portion 62a includes a plurality of openings. Each of the plurality of openings communicates with an ink or fluid supply path (the ink supply pipe 44 or the solvent supply pipe 54). The first electrical connection portion 62b includes a terminal based on a predetermined standard. This terminal is electrically connected to the control unit 101 via the connection cable 107.

### (Head Module 1B)

As illustrated in FIGS. 5A and 5B, the head module 1B is a component that is mountable on and dismountable from the head main body 1A. The head module 1B can be referred to as a "distal end" in the print head 1 or a "supported portion" supported by the head main body 1A. The head module 1B is connected to the connection cable 107 via the head main body 1A and can also be referred to as a "fluid supplied portion" to which ink or a solvent is supplied from the connection cable 107 via the head main body 1A.

Specifically, the head module 1B according to the present embodiment includes the second housing portion 70, a support plate portion 71, and a second engagement portion 72.

### -Second Housing Portion 70-

The second housing portion 70 constitutes the housing 10 of the entire print head 1 together with the first housing portion 60 of the head main body 1A. The second housing portion 70 according to the present embodiment has a shape extending in the up-down direction, for example, a rectangular tube shape. The second housing portion 70 is made of, for example, metal (aluminum die-cast).

As illustrated in FIG. 3, the nozzle 12, the charging electrode 13, the charge detection sensor 14, the deflection electrode 15, the gutter 16, the cleaning nozzle 17, the high-voltage generation unit 18, the storage unit 19, the first magnet 23, and the second magnet 24 are accommodated in the second housing portion 70.

### Is contained.

As illustrated in FIGS. 2B and 3, the high-voltage generation unit 18 is located in the head module 1B, not in the head main body 1A. Regardless of the mounting/dismounting situation of the head main body 1A and the head module 1B, the electrical connection between the deflection electrode 15 and the high-voltage generation unit 18 is maintained.

As described above, in the present embodiment, the head module 1B is provided with the high-voltage generation unit 18 that generates a high voltage applied to the deflection electrode 15.

Similarly, the head module 1B according to the present embodiment includes the storage unit 19 that stores at least one of information indicating the ink type, information regarding the life of the inkjet recording apparatus I, and correction information for adjusting the high voltage by the high-voltage generation unit 18.

The storage unit 19 is located not in the head main body 1A but in the head module 1B. Regardless of the mounting/dismounting situation of the head main body 1A and the head module 1B, the storage unit 19 holds the stored contents.

As illustrated in FIG. 3, the first magnet 23 is located at the upper end of the head module 1B. In a state where the head module 1B is mounted on the head main body 1A, the first magnet 23 is located so as to be aligned with the first sensor 21 of the head main body 1A in the up-down direction.

As illustrated in FIG. 3, the second magnet 24 is located at the upper end of the head module 1B. In a state where the head module 1B is mounted on the head main body 1A, the second magnet 24 is located so as to be aligned with the second sensor 22 of the head main body 1A in the up-down direction.

As described above, when at least one of the first sensor 21 and the second sensor 22 is provided in the head module 1B, a magnet corresponding to the one sensor is provided in the head main body 1A.

### -Support Plate Portion 71-

The support plate portion 71 partitions the internal space of the second housing portion 70. The support plate portion 71 according to the present embodiment has a plate shape extending in the up-down direction and the left-right direction, for example, a rectangular plate shape. The support plate portion 71 is made of, for example, resin.

As illustrated in FIG. 5B, the nozzle 12, the charging electrode 13, the charge detection sensor 14, the deflection electrode 15, and the gutter 16 are attached to the support plate portion 71. As a result, the nozzle 12, the charging electrode 13, the charge detection sensor 14, the deflection electrode 15, and the gutter 16 are fixed to the head module 1B.

### -Second Engagement Portion 72-

As illustrated in FIG. 6B, the second engagement portion 72 is located at the lower end of the head module 1B. The second engagement portion 72 engages with the first engagement portion 62 of the head main body 1A when the head module 1B is mounted on the head main body 1A. The engagement herein may be read as "fitting".

Specifically, the second engagement portion 72 according to the present embodiment has a recessed shape in which the upper end of the second housing portion 70 is recessed downward. Specifically, the second engagement portion 72 forms an insertion hole recessed downward from the upper surface of the second housing portion 70 and having a circular cross section.

A second fluid connection portion 72a and a second electrical connection portion 72b are located on the bottom surface of the second engagement portion 72. The second fluid connection portion 72a includes a plurality of cylindrical bodies. Each of the plurality of cylindrical bodies communicates with the nozzle 12 and the cleaning nozzle 17. The second electrical connection portion 72b includes a terminal based on a predetermined standard. This terminal is electrically connected to the nozzle 12, the charging electrode 13, the charge detection sensor 14, the gutter sensor 16b, the high-voltage generation unit 18, and the storage unit 19 via an electric wire in the print head 1.

When the head module 1B is mounted on the head main body 1A, the first fluid connection portion 62a and the second fluid connection portion 72a are fluidly connected. Thus, the ink and the solvent can be supplied to the head module 1B.

When the head module 1B is mounted on the head main body 1A, the first electrical connection portion 62b and the second electrical connection portion 72b are electrically connected. With this connection, as illustrated in FIG. 2B, the control unit 101 is electrically connected to the nozzle 12, the charging electrode 13, the charge detection sensor 14, the gutter sensor 16b, the high-voltage generation unit 18, and the storage unit 19.

<Specific Example of Mounting/Dismounting Process>

Mounting and dismounting of the head main body 1A and the head module 1B are performed at the time of manufacturing the print head 1 or the like. The mounting/dismounting processing unit 101a according to the present embodiment executes a process related to mounting/dismounting of the head main body 1A and the head module 1B.

### (Removal Sequence in Normal State)

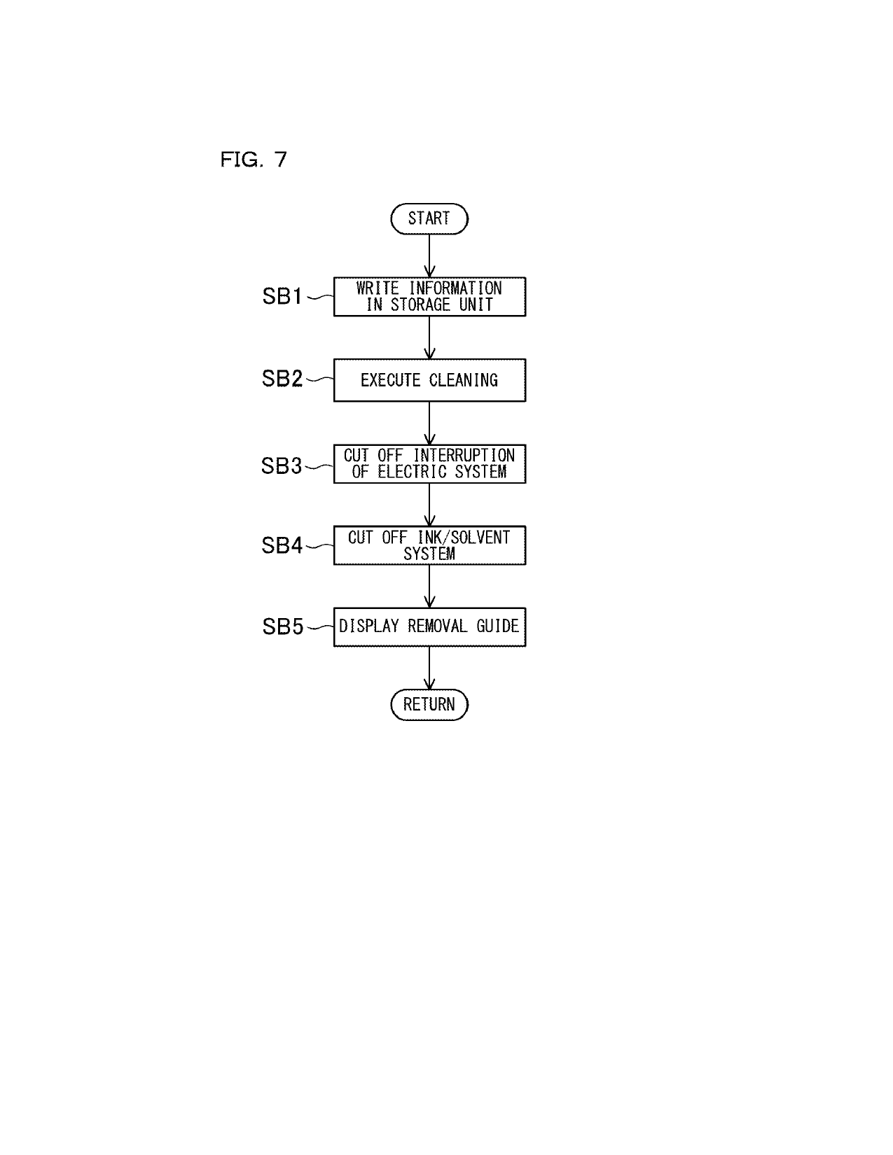

FIG. 7 is a flowchart illustrating a removal sequence in a normal state. The flowchart illustrated in FIG. 7 illustrates a control process executed by the mounting/dismounting processing unit 101a when the operation display unit 103 receives an instruction (hereinafter, also referred to as "removal instruction") for detaching the head module 1B from the head main body 1A.

First, in step SB1 of FIG. 7, the mounting/dismounting processing unit 101a writes various types of information in the storage unit 19. The information written in step SB1 includes at least one of "module type", "ink type", "manufacturing serial", "deflection voltage adjustment value", "deflection monitor adjustment value", and "character height adjustment value".

Here, the "module type" is information indicating the type of the head module 1B. This information is used, for example, for determination of 'whether controller 100 can specify printing of standard size, printing of small letters, high-speed printing, printing of L letter, and the like'.

The "ink type" is information indicating the type of ink used for printing. This information is used, for example, to determine 'whether the ink type matches the ink type stored in the controller 100'.

The "manufacturing serial" is information indicating the manufacturing serial of the inkjet recording apparatus I. This information is used for traceability applications, history management of manufacturing and repair, and the like.

The "deflection voltage adjustment value" is correction information for adjusting the high voltage by the high-voltage generation unit 18. This information is used to adjust the individual difference so that the deflection voltage (high voltage applied to the deflection electrode 15) in the head module 1B becomes a specified value.

The "deflection monitor adjustment value" is correction information for adjusting the high voltage by the high-voltage generation unit 18. This information is used to adjust an individual difference of a deflection voltage monitoring circuit (not illustrated) in the head module 1B.

The "character height adjustment value" is information indicating the height of characters to be printed by the print head 1. This information is used to adjust the height of the characters so that there is no difference among the head modules 1B.

In subsequent step SB2, the control unit 101 cleans the inside of the print head 1 by ejecting a solvent into the print head 1 from the nozzle 12, the cleaning nozzle 17, and the like. The solvent used at that time is collected by a separate cleaning placement portion (not illustrated) on which the print head 1 is placed at the time of cleaning.

In subsequent step SB3, the mounting/dismounting processing unit 101a stops the power supply from the controller 100 to the print head 1 and cuts off the electrical system of the print head 1. In step SB3, at least the application of the pulse potential from the controller 100 to the charging electrode 13 is prohibited.

In subsequent step SB4, the mounting/dismounting processing unit 101a stops the supply of the ink and the solvent from the controller 100 to the head module 1B, and cuts off the ink/solvent system of the head module 1B. In step SB4, at least the mounting/dismounting processing unit 101a inputs control signals to the 14th valve V14, the 12th valve V12, and the 15th valve V15. When the control signal is input, these valves transition from the open state to the closed state or are held in the closed state.

In subsequent step SB5, the mounting/dismounting processing unit 101a displays a removal guide including a still image, a moving image, a message, and the like on the display unit 103a. The removal guide represents a procedure for removing the head module 1B from the head main body 1A. The user can smoothly remove the head module 1B according to the removal guide displayed on the display 103a.

### (Removal Sequence in Abnormal State)

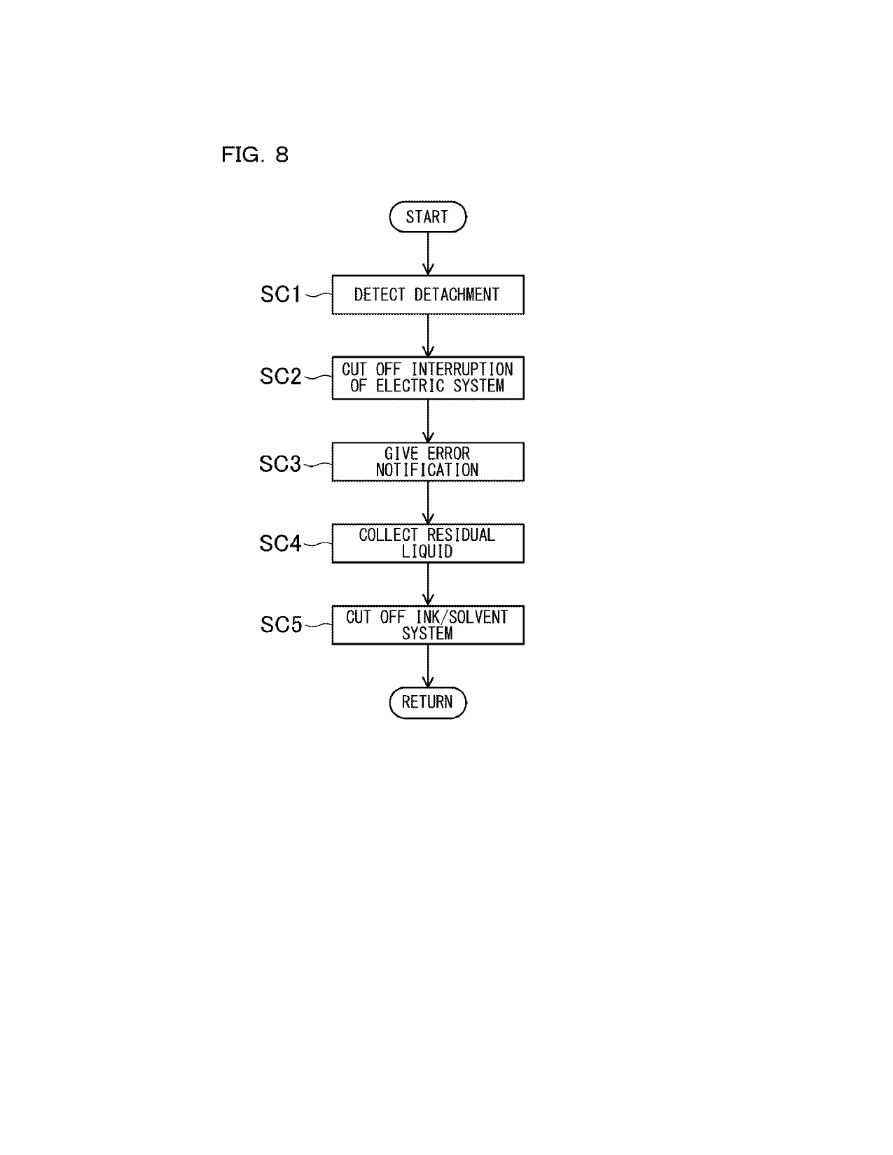

FIG. 8 is a flowchart illustrating a removal sequence in an abnormal state. The flowchart illustrated in FIG. 8 illustrates a control process executed by the mounting/dismounting processing unit 101a on condition that the operation display unit 103 does not receive the removal instruction and the head module 1B is unintentionally removed from the head main body 1A.

First, in step SC1 of FIG. 7, the mounting/dismounting processing unit 101a detects detachment of the head module 1B from the head main body 1A. This detection is performed based on a detection signal output from at least one of the first sensor 21 and the second sensor 22.

In subsequent step SC2, the mounting/dismounting processing unit 101a stops power supply from the controller 100 to the head module 1B, and cuts off the electric system of the head module 1B. In step SB3, at least the application of the pulse potential from the controller 100 to the charging electrode 13 is prohibited.

In subsequent step SC3, the mounting/dismounting processing unit 101a displays an error notification such as a still image, a moving image, or a message on the display unit 103a. The error notification in step SC3 is a notification indicating that the head module 1B has been unintentionally removed from the head main body 1A.

In subsequent step SC4, the control unit 101 collects the ink or solvent (residual liquid) remaining in the print head 1. This recovery can be performed by, for example, the suction path 47 and the seventh ink pipe 44g in FIG. 4.

In subsequent step SC5, the mounting/dismounting processing unit 101a stops the supply of the ink and the solvent from the controller 100 to the head module 1B, and cuts off the ink/solvent system of the head module 1B. In step SC5, at least control signals are input from the mounting/dismounting processing unit 101a to the 14th valve V14, the 12th valve V12, and the 15th valve V15, and these valves transition from the open state to the closed state or are held in the closed state.

### (Mounting Sequence)

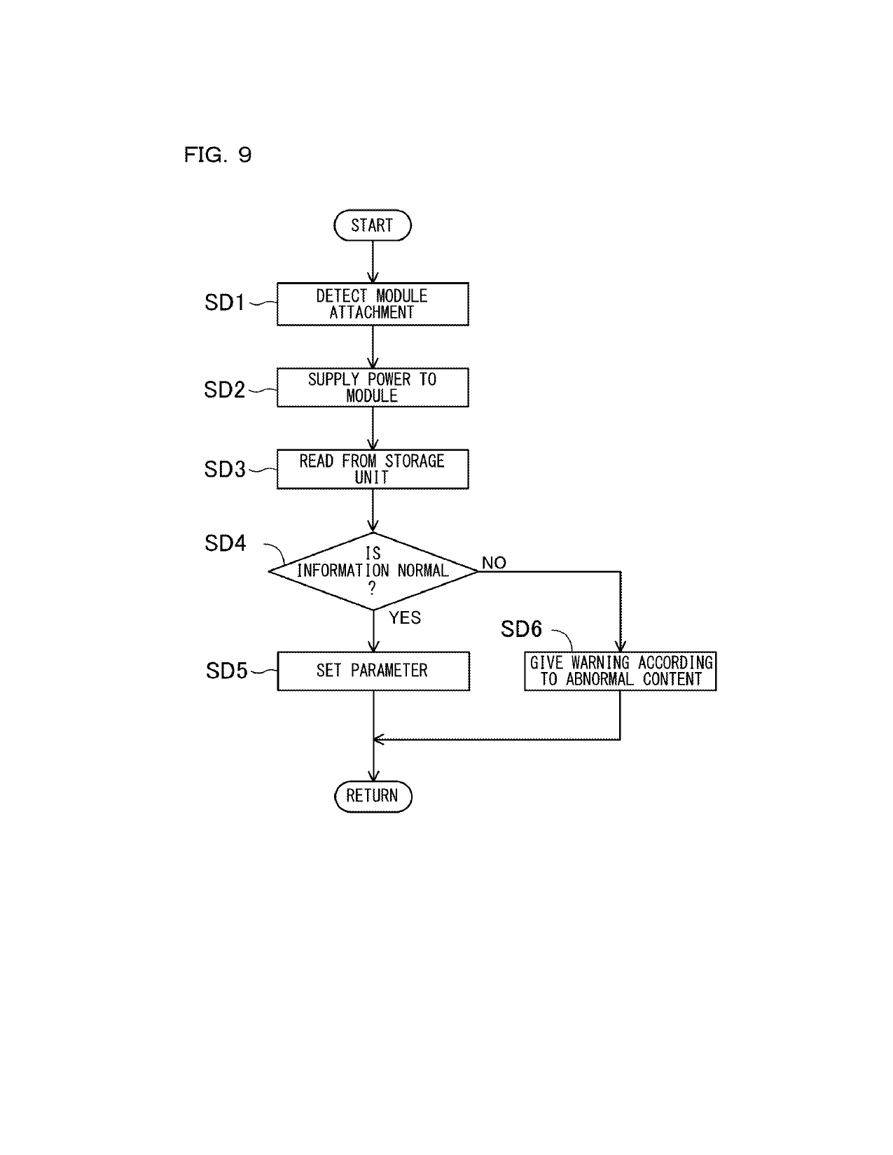

FIG. 9 is a flowchart illustrating a mounting sequence (attachment sequence) of the head module 1B. The flowchart illustrated in FIG. 9 illustrates a control process executed by the mounting/dismounting processing unit 101a when the head module 1B is mounted (attached) to the head main body 1A. For simplification of the drawing, the "head module" is simply referred to as a "module" in FIG. 9.

First, in step SD1 of FIG. 9, the mounting/dismounting processing unit 101a detects mounting of the head module 1B to the head main body 1A. This detection is performed based on a detection signal output from at least one of the first sensor 21 and the second sensor 22.

In subsequent step SD2, the mounting/dismounting processing unit 101a restarts the power supply from the controller 100 to the head module 1B. In step SD2, at least a pulse potential is applied from the controller 100 to the charging electrode 13.

In subsequent step SD3, the mounting/dismounting processing unit 101a reads information from the storage unit 19. The information read in step SD3 includes, for example, "the number of times of mounting/dismounting".

Here, the "number of times of mounting/dismounting" is information related to the life of the inkjet recording apparatus I. Specifically, this information indicates the number of times the head module 1B is mounted on and dismounted from the head main body 1A.

In subsequent step SD4, the mounting/dismounting processing unit 101a determines whether or not the information read in step SD3 is normal. This determination can be made on the basis of, for example, "whether or not the number of times of mounting/dismounting exceeds a predetermined reference value".

In a case where the determination in step D4 is NO, that is, in a case where it is determined that some abnormality is included in the information, the mounting/dismounting processing unit 101a advances the control process to step SD6. In this case, the mounting/dismounting processing unit 101a issues a warning according to the abnormality content such as that the print head 1 has reached its end of life. This warning can be performed, for example, by displaying a message on the display unit 103a.

On the other hand, when the determination in step D4 is YES, the mounting/dismounting processing unit 101a sets various parameters related to the print head 1, such as the pulse potential applied to the charging electrode 13, to predetermined values.

### Improvement of Manufacturing Efficiency in Present Embodiment

In the case of a general continuous inkjet recording apparatus a nozzle, a charging electrode, a deflection electrode, and a gutter are accommodated in the print head. Therefore, a connection cable connecting the controller and the print head includes a plurality of conduits and electric wires, such as a supply pipe for supplying ink, a collection pipe for collecting ink, a charging electrode, and an electric wire for applying a predetermined voltage to a deflection voltage.

Furthermore, in a case where a known connection cable is used, the inkjet recording apparatus has a so-called integrated configuration in which the print head and the controller are connected via the connection cable.

Incidentally, in general, when manufacturing a print head, an operation (installation operation) of installing and bonding a charging electrode, a deflection electrode, and the like in the print head is required. After the installation operation is completed, an operation (drying operation) of drying the print head in a high-temperature chamber is also required. In addition, various inspections may be performed in parallel with the drying operation or before and after the drying operation. As such an inspection, for example, an inspection related to operation of a nozzle installed in a print head is conceivable.

However, in the case of using the integrated configuration as described above, the presence of such an operation and inspection hinders improvement in productivity in the inkjet recording apparatus.

For example, in a drying operation, not only a print head but also a controller needs to be placed in a high-temperature chamber together. Therefore, it takes a complicated time and effort to secure an installation space of the controller or bring the controller in, and as a result, it hinders improvement in productivity.

In addition, in a case where an abnormality occurs in various inspections of the print head, even if there is no problem in the controller, the inkjet recording apparatus as a whole is not completed as a product until the abnormality of the print head is eliminated, and thus, productivity improvement is also hindered.

The problem to be solved by the embodiment described above is to increase the manufacturing efficiency of the inkjet recording apparatus and eventually, to improve the productivity. To solve such a problem, according to the present embodiment, a part of the print head 1 is modularized as the head module 1B that is mountable on and dismountable from the head main body 1A. As exemplified in FIG. 3, the head module 1B accommodates the nozzle 12, the charging electrode 13, and the deflection electrode 15, and incorporates the high-voltage generation unit 18 for generating a high voltage (for example, several kv) for the deflection electrode 15.

Since the high-voltage generation unit 18 is incorporated in the head module 1B, a high voltage signal caused by the high-voltage generation unit 18 is not transmitted and received between the head main body 1A and the head module 1B. Therefore, the insulation distance can be shortened, and the connecting portions between the head main body 1A and the head module 1B, that is, the first and second engagement portions 62 and 72 can be simplified or made compact.

By using such a head module 1B, it is possible to remove the head module 1B from the head main body 1A and dry the head module 1B at the time of manufacturing the inkjet recording apparatus, or replace the head module 1B with another head module 1B having no abnormality when there is an abnormality in inspection of the head module 1B to complete a product. As a result, the manufacturing efficiency of the inkjet recording apparatus I can be increased, and eventually, the productivity can be improved.

Further, since the 14th valve V14 is disposed inside the head main body 1A, when the head module 1B is removed from the head main body 1A at the time of manufacturing the inkjet recording apparatus I, leakage of ink from the head main body 1A can be suppressed.

In general, the leakage of ink contaminates the surrounding environment of the factory, and thus it takes time and effort to clean the leakage of ink. In consideration of such trouble, the leakage of ink is disadvantageous in enhancing the manufacturing efficiency of the inkjet recording apparatus I.

On the other hand, by suppressing the leakage of ink as described above, the productivity of the inkjet recording apparatus I can be improved.

In addition, by prohibiting the application of the high voltage signal to the charging electrode 13 when the head module 1B is removed, it is possible to prevent the user from getting an electric shock without turning off the controller 100. Therefore, the head module 1B can be safely removed even in the live state. As a result, various manufacturing steps can be efficiently performed, and the productivity of the inkjet recording apparatus I can be improved.

Furthermore, as exemplified in FIG. 3, by providing the storage unit 19 in the head module 1B, information can be read from the head module 1B alone without moving the print head 1 and eventually, the entire inkjet recording apparatus I. As a result, various inspections can be efficiently performed, and eventually, the productivity of the inkjet recording apparatus I can be improved.

In addition, as exemplified in FIG. 2B, the first sensor 21 and the second sensor 22 are provided in the print head 1, and at least some electric paths are made independent between the first sensor 21 and the second sensor 22.

In this way, even if an inconvenience occurs in one of the independent electric paths, the detection signal of the first sensor 21 or the second sensor 22 can be input to the controller 100 through the other electric path.

In addition, as exemplified in FIG. 18, by connecting the attachment portion 91 to the head main body 1A, stress acting on the connection portion between the head main body 1A and the head module 1B, particularly stress received from the connection cable 107 can be alleviated. This can stabilize the positioning of the print head 1.

### <First Modification of Inkjet Recording System S>

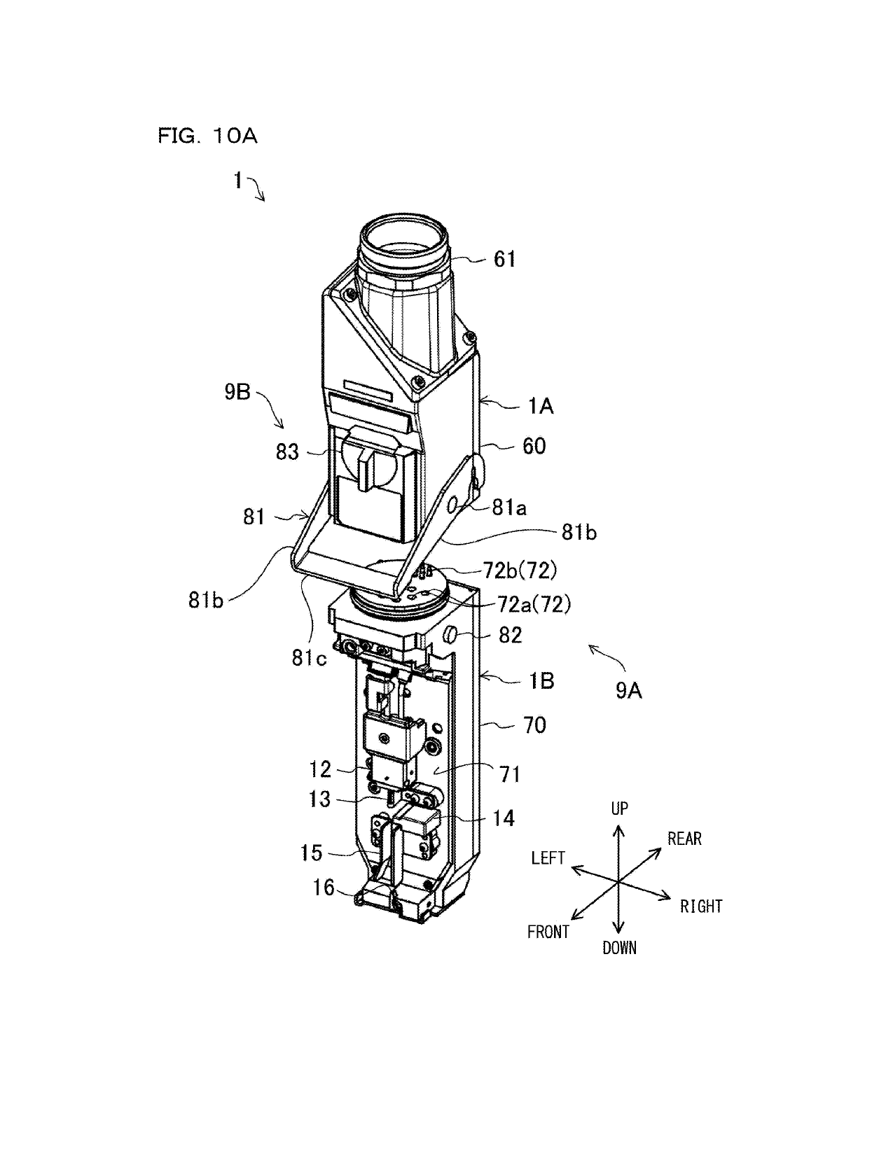

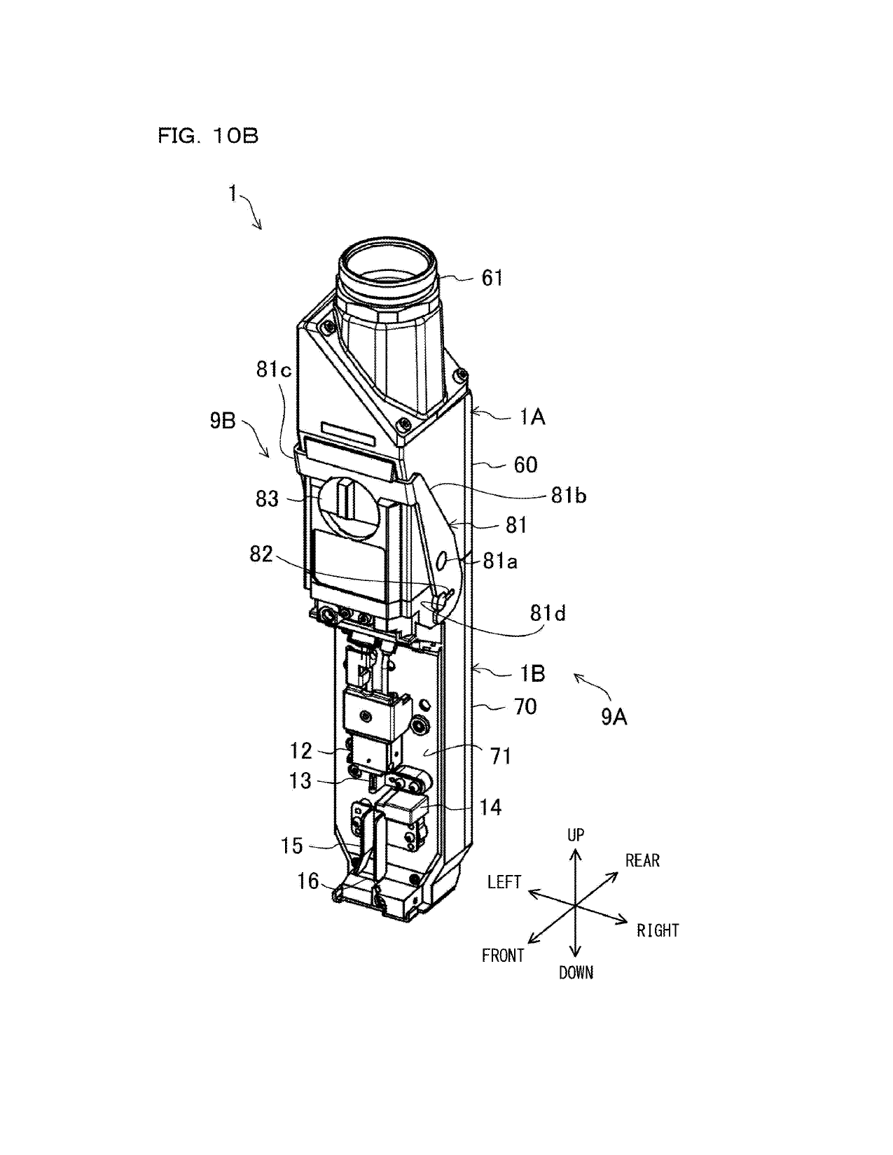

FIG. 10A is a diagram corresponding to FIG. 5A illustrating a configuration of a head main body 1A and a head module 1B according to a first modification. FIG. 10B is a diagram corresponding to FIG. 5B illustrating the print head 1 after assembly according to the first modification.

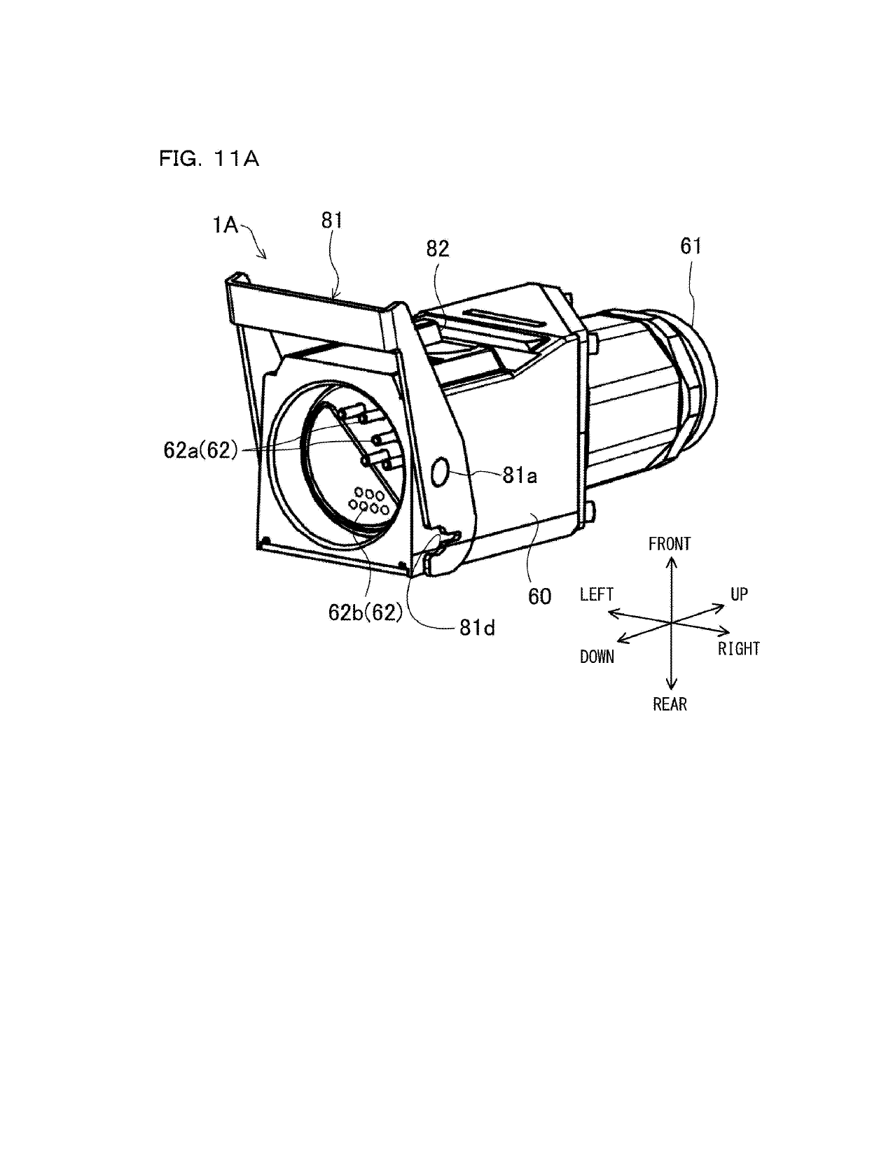

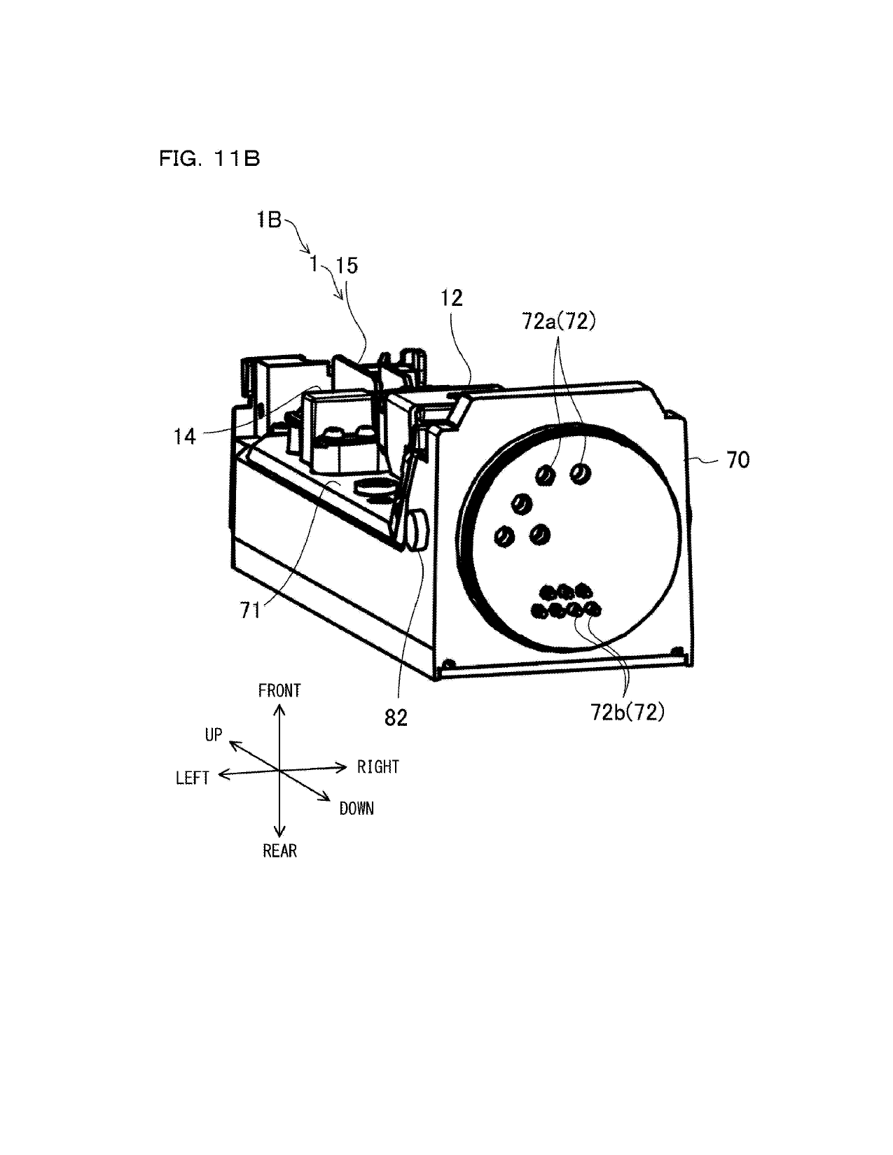

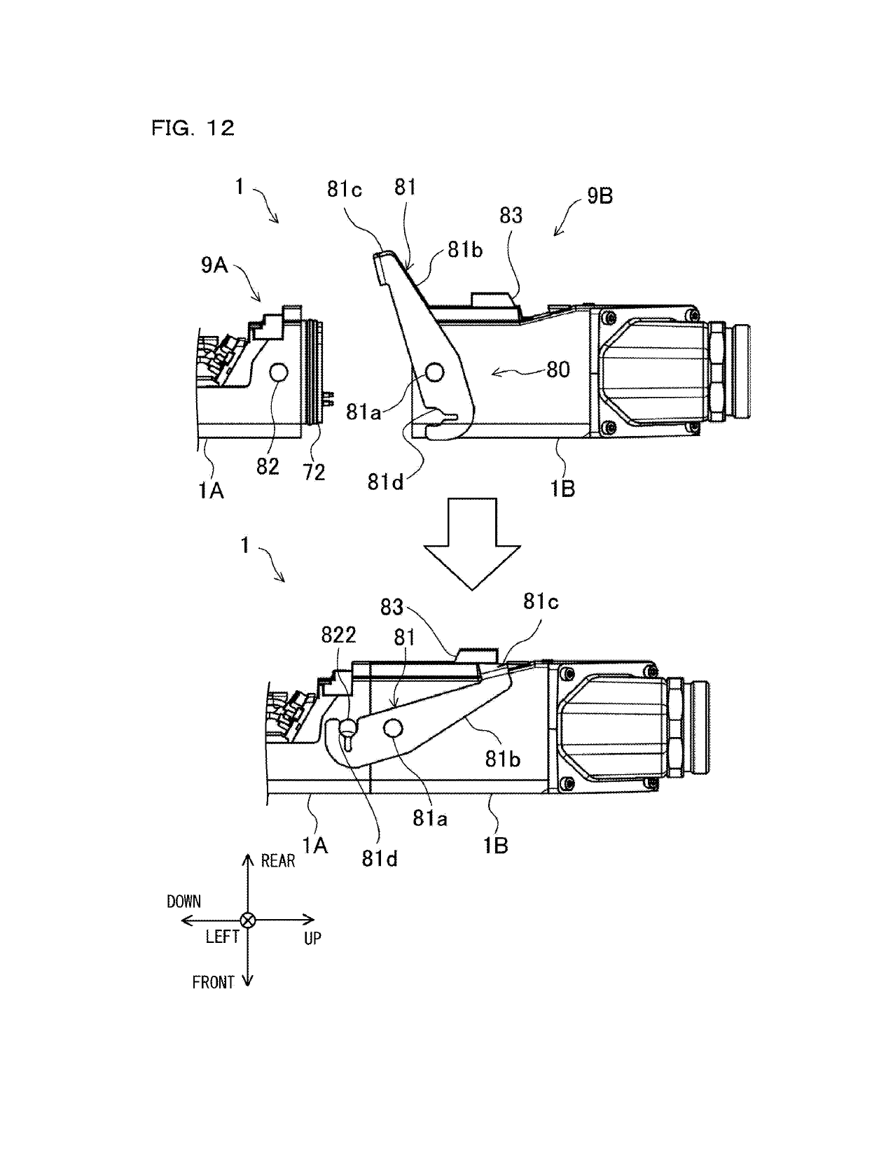

FIG. 11A is a perspective view illustrating first and second lock mechanisms 80 and 90, and FIG. 11B is a perspective view illustrating the first and second lock mechanisms 80 and 90. FIG. 12 is a side view illustrating operations of the first and second lock mechanisms 80 and 90.

Note that, in FIGS. 10A, 10B, 11A, 11B, and 12, elements having the same configurations and structures as those of the embodiment described above are denoted by the same reference numerals as those of the embodiment described above.

The print head 1 according to the first modification includes a first lock mechanism 9A for locking the head module 1B with respect to the head main body 1A in addition to the head main body 1A and the head module 1B configured in the same manner as in the embodiment described above. The first lock mechanism 9A restricts detachment of the head module 1B from the head main body 1A.

Furthermore, the print head 1 according to the first modification includes a second lock mechanism 9B that further locks the lock itself by the first lock mechanism 9A. The print head 1 according to the first modification can be said to be a print head having a so-called double lock structure. The second lock mechanism 9B further restricts release of restriction by the first lock mechanism 9A.

Hereinafter, configurations related to the first lock mechanism 9A and the second lock mechanism 9B will be described in detail. As illustrated in FIGS. 10A and 10B, the print head 1 according to the first modification includes an arm member 81, a first lock portion 82, and a second lock portion 83.

The arm member 81 is turnably supported by the head main body 1A. Specifically, the arm member 81 is assembled to protruding portions 81a protruding from the left and right side surfaces of the first housing portion 60, and turns around a rotation axis extending in the left-right direction around the protruding portions 81a.

More specifically, as illustrated in FIG. 10A, the arm member 81 includes first members 81b extending in an arm shape from each of the left and right protrusions 81a, and a second member 81c extending in the left-right direction so as to connect the distal ends of the two first members 81b. The first member 81b turns about the protrusion 81a relative to the protrusion 81a. The second member 81c turns integrally with the first members 81b.

As illustrated in FIGS. 10B and 11A, the other end of the first member 81b is provided with a recessed portion 81d recessed to receive the first lock portion 82. As illustrated in FIG. 11B, the first lock portion 82 protrudes from both left and right side surfaces of the second housing portion 70. The term "the other end of the first member 81b" as used herein refers to an end of the first member 81b located on the opposite side of the second member 81c with respect to the protruding portion 81a.

The first lock mechanism 9A includes the arm member 81 and the first lock portion 82. That is, as illustrated in the upper stage and the lower stage of FIG. 12, when assembling the print head 1, an operator first inserts the second engagement portion 72 of the head module 1B into the first engagement portion 62 of the head main body 1A, and brings the head main body 1A and the head module 1B into close contact with each other.

In this state, the arm member 81 is turned around the protruding portion 81a, and the first lock portion 82 is fitted into the recessed portion 81d. Accordingly, detachment of the head module 1B from the head main body 1A is restricted.

The second lock portion 83 is rotatably supported by the head main body 1A. Specifically, the second lock portion 83 is assembled to the front surface of the first housing portion 60, and rotates around a rotation axis extending in the front-rear direction with a central portion of the second lock portion 83 as a rotation axis.

As illustrated in FIGS. 10A and 10B, by rotating the second lock portion 83 by 180°, switching is made between a state (see FIG. 10A) in which displacement of the second member 81c with respect to the first housing portion 60 is allowed and a state (see FIG. 10B) in which displacement of the second member 81c with respect to the first housing portion 60 is restricted.

The second lock mechanism 9B includes the arm member 81 and the second lock portion 83. That is, as illustrated in the lower part of FIGS. 10B and 12, the operator rotates the second lock portion 83 in a state where detachment of the head module 1B from the head main body 1A is restricted by the first lock mechanism 9A. As a result, displacement of the second member 81c with respect to the first housing portion 60 is restricted. As a result, the release of the restriction by the first lock mechanism 9A is further restricted.

In addition, the inkjet recording apparatus I according to the first modification additionally performs a process related to the first and second lock mechanisms 9A and 9B. Specifically, the mounting/dismounting processing unit 101a according to the first modification determines whether or not the restriction by the second lock mechanism 9B is released on the basis of the rotation state of the second lock portion 83. Then, in a case where it is determined that the restriction by the second lock mechanism 9B is released, the mounting/dismounting processing unit 101a executes a predetermined process.

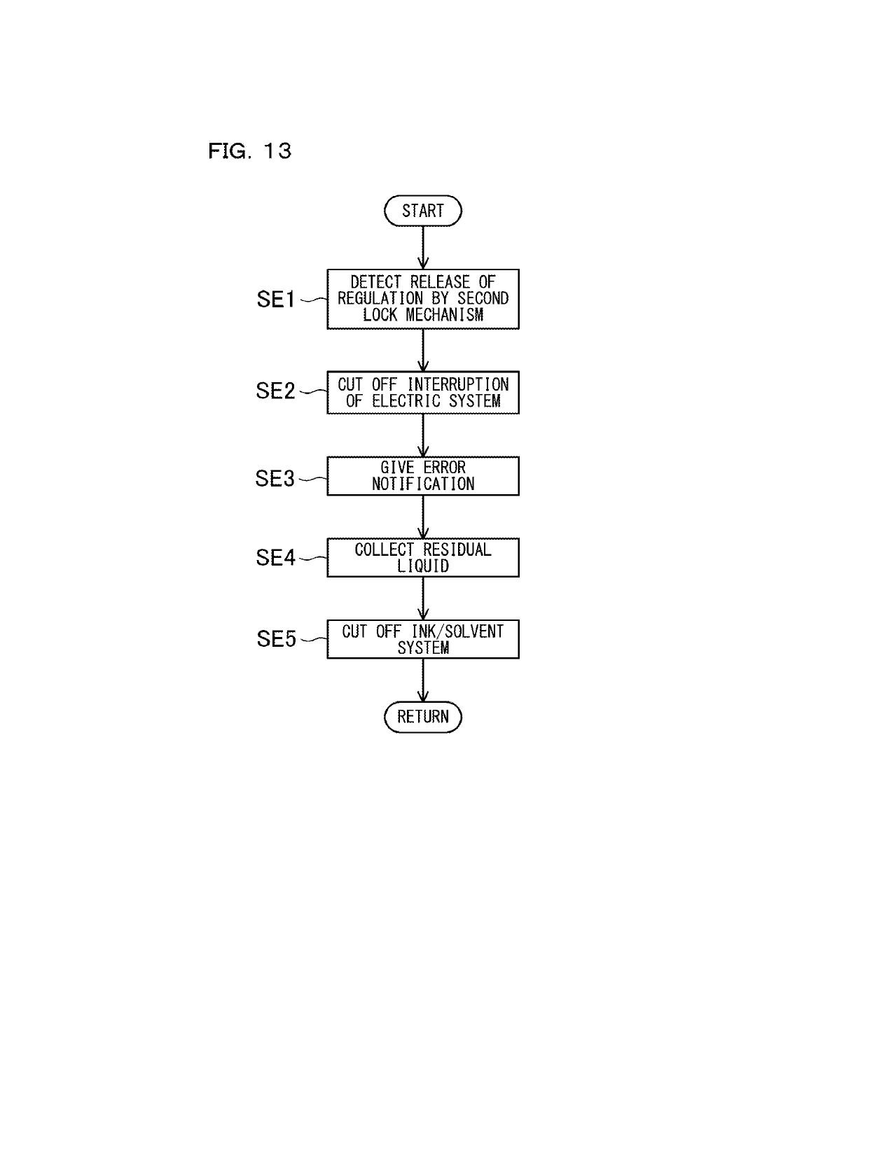

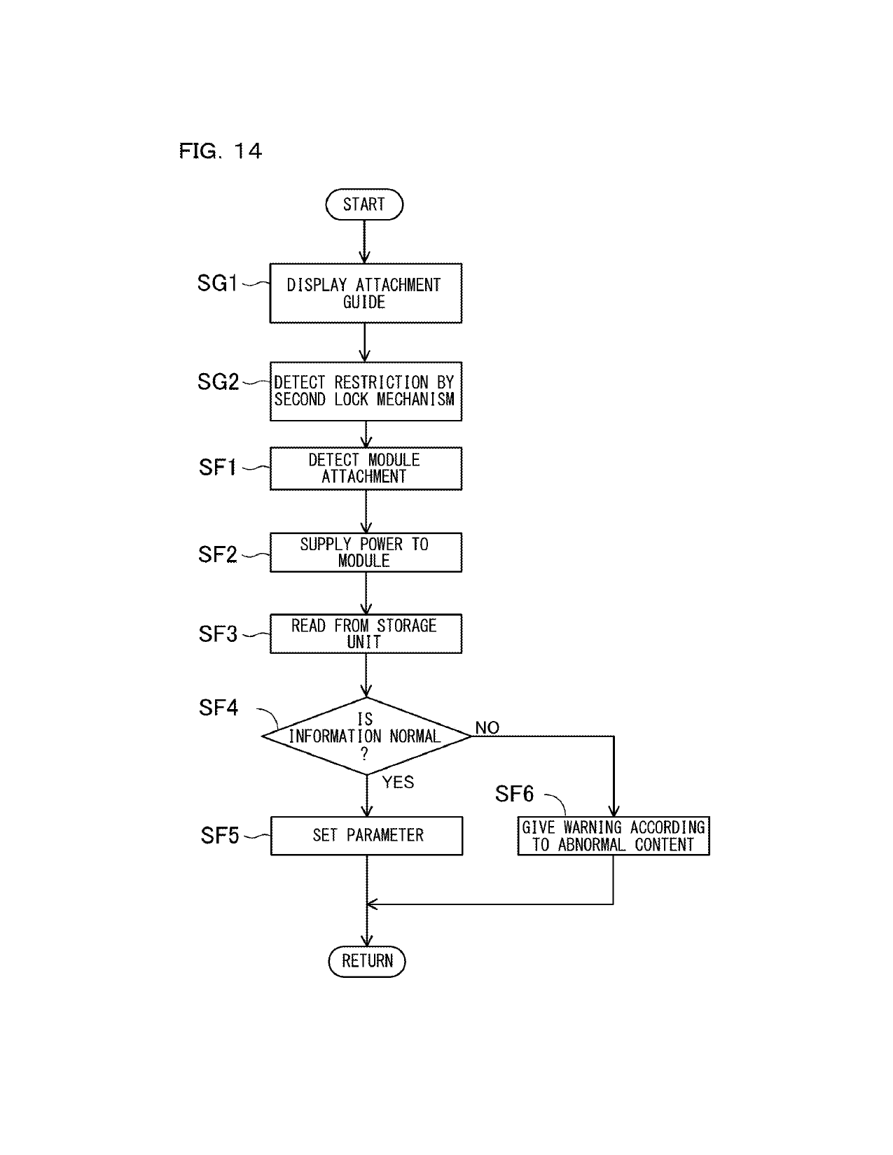

Hereinafter, a process unique to the first modification will be described. FIG. 13 is a diagram corresponding to FIG. 8 illustrating a removal sequence according to the first modification. FIG. 14 is a diagram corresponding to FIG. 9 illustrating a mounting sequence according to the first modification.

First, although the removal sequence exemplified in FIG. 7 is common between the embodiment and the first modification, display related to the first and second lock mechanisms 9A and 9B is performed in the process of step SB5 in FIG. 7.

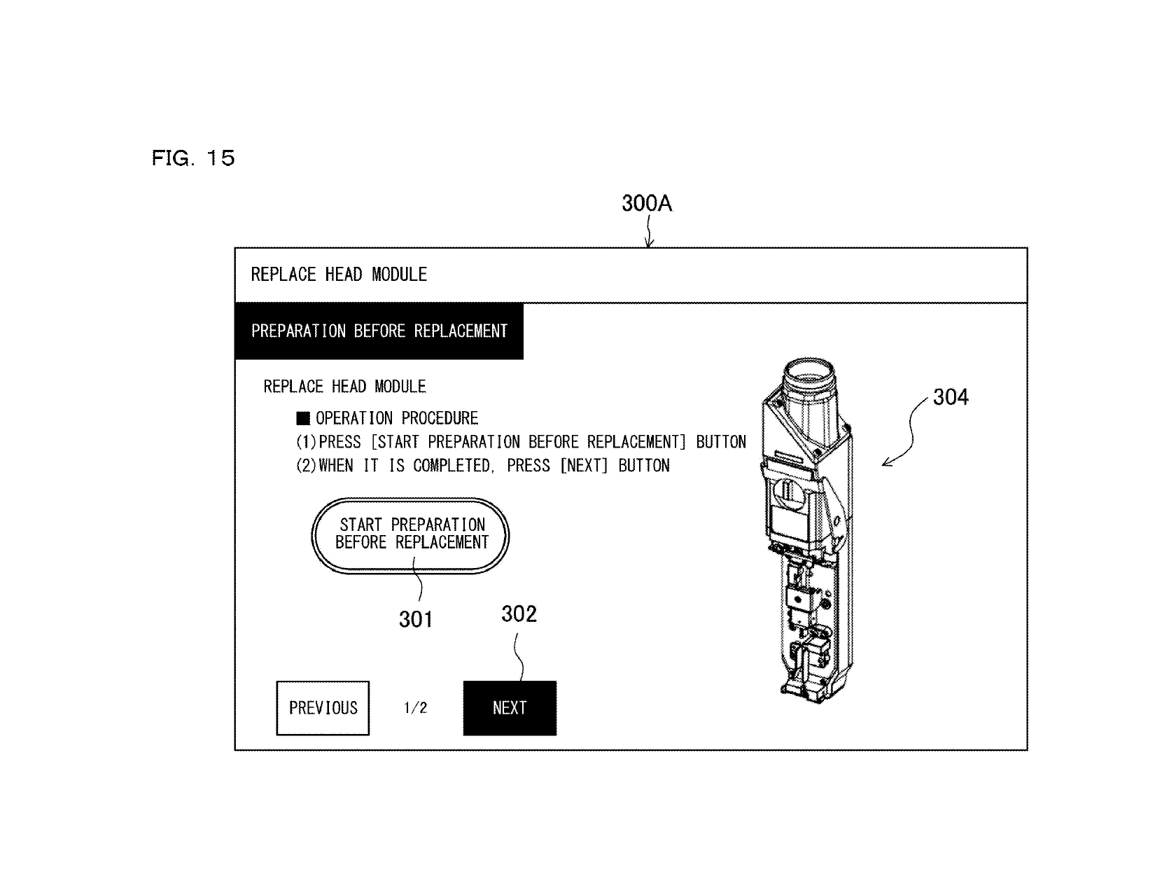

Specifically, the inkjet recording apparatus I according to the first modification displays a screen 300A exemplified in FIG. 15 on the display unit 103a in the process of step SB5 in FIG. 7. The screen 300A displays an operation procedure to be performed before replacement (before removal) of the head module 1B, buttons 301 and 302 to be pressed in the operation procedure, and an image 304 illustrating the appearance of the print head 1. The operator can proceed with the replacement (removal) of the head module 1B according to the contents of the screen 300A.

The processes in steps SE2 to SE5 in FIG. 13 are substantially the same as the processes in steps SC2 to SC5 in FIG. 8, respectively. The control process of FIG. 13 is different from step SC1 of FIG. 8 in the content of step SE1.

Specifically, in step SE1, the mounting/dismounting processing unit 101a determines whether or not the restriction by the second lock mechanism 9B is released on the basis of the rotation state of the second lock portion 83. Then, in a case where it is determined that the restriction by the second lock mechanism 9B is released, the mounting/dismounting processing unit 101a advances the control process to step SE2.

In step SE2, the mounting/dismounting processing unit 101a stops the power supply from the controller 100 to the head module 1B and cuts off the electric system of the head module 1B. In step SB3, at least the application of the pulse potential from the controller 100 to the charging electrode 13 is prohibited. In a stage in which the restriction by the second lock mechanism 9B is released, the restriction by the first lock mechanism 9A still functions. By advancing the control process to step SE2 at that stage, it is possible to realize a process that stands on the safer side.

The processes in steps SF1 to SF6 in FIG. 14 are substantially the same as the processes in steps SD1 to SD6 in FIG. 9, respectively. The control process of FIG. 14 is different from the control process of FIG. 8 in that the process of step SG1 and the process of step SG2 are present.

First, in step SG1, the mounting/dismounting processing unit 101a displays an attachment guide including a still image, a moving image, a message, and the like on the display unit 103a. The attachment guide represents a procedure for mounting the head module 1B to the head main body 1A.

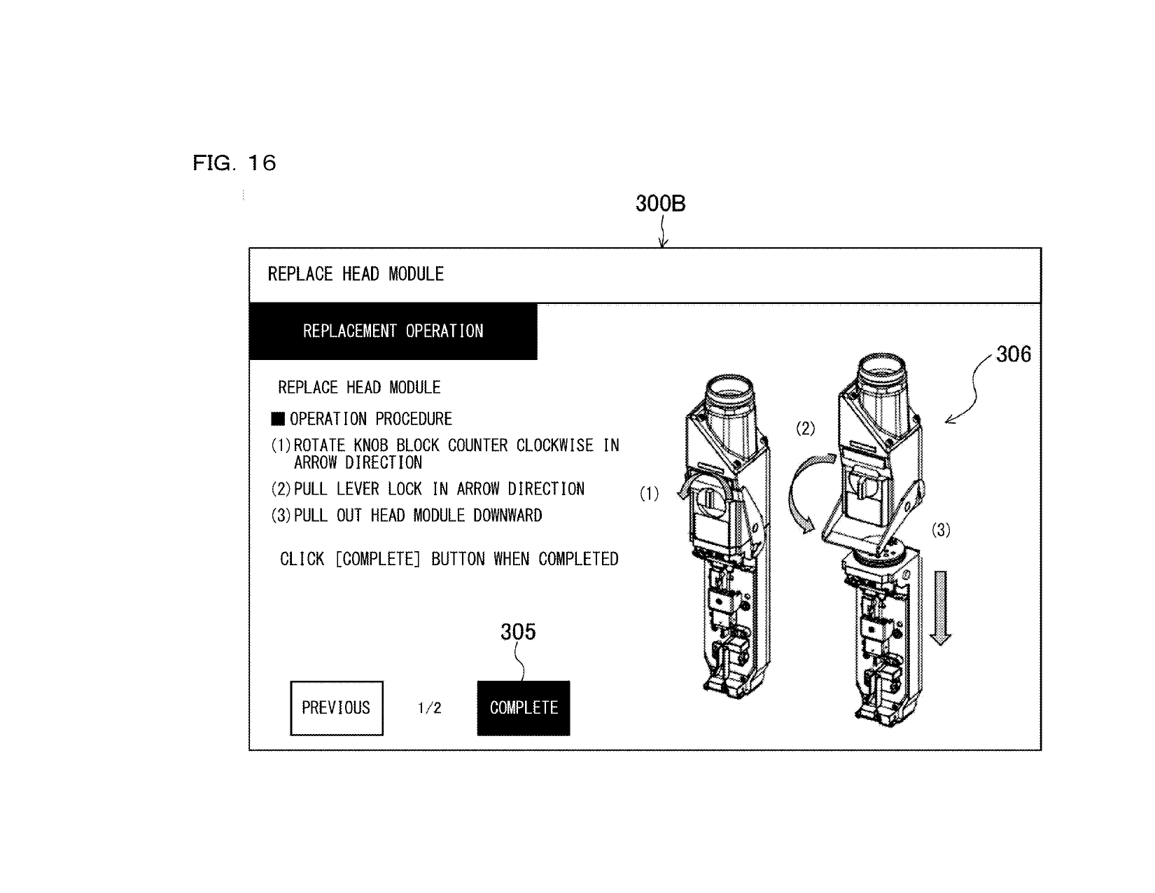

Specifically, the inkjet recording apparatus I according to the first modification displays a screen 300B exemplified in FIG. 16 on the display unit 103a in the process of step SG1 in FIG. 14. The screen 300B displays an operation procedure to be performed at the time of replacement (mounting) of the head module 1B, a button 305 to be pressed at the time of the operation procedure, and an image 306 indicating the appearance of the print head 1 and the movement of the first and second lock mechanisms 9A and 9B. The operator can proceed with the replacement (mounting) of the head module 1B according to the contents of the screen 300A.

In subsequent step SG2, the mounting/dismounting processing unit 101a determines whether or not restriction by the second lock mechanism 9B is set on the basis of the rotation state of the second lock portion 83. Then, in a case where it is determined that the restriction by the second lock mechanism 9B is set, the mounting/dismounting processing unit 101a advances the control process to step SF1. The subsequent process is as described with reference to FIG. 9.

That is, as described in step SF2, the mounting/dismounting processing unit 101a resumes the power supply from the controller 100 to the head module 1B on condition that the restriction by the second lock mechanism 9B is set. In this step SF2, at least a pulse potential is applied from the controller 100 to the charging electrode 13. In this manner, not only the detection results based on the first and second sensors 21 and 22, but also the setting of the restriction by the second lock mechanism 9B is used as the power supply restart condition, so that it is possible to realize a process that stands on the safer side.

### <Significance of First Modification>

In the case of a general continuous inkjet recording apparatus a nozzle, a charging electrode, a deflection electrode, and a gutter are accommodated in the print head. Therefore, a connection cable connecting the controller and the print head includes a plurality of conduits and electric wires, such as a supply pipe for supplying ink, a collection pipe for collecting ink, a charging electrode, and an electric wire for applying a predetermined voltage to a deflection voltage.

Furthermore, in a case where a known connection cable is used, the inkjet recording apparatus has a so-called integrated configuration in which the print head and the controller are connected via the connection cable.

Here, as a result of ink clogging in the nozzles of the print head or a failure in the charging electrode and/or the deflection electrode, the print head may need to be repaired.

However, in the case of using the integrated configuration as described above, since the print head and the controller are integrated, both the print head and the controller need to be sent to a manufacturer, a repair shop, or the like to be repaired, or a maintenance person needs to go to an installation site of the inkjet recording apparatus to repair it.

However, since it takes a lot of time for the production line (corresponding to the conveyance line L in the present specification) to be restored, there is a possibility that the operation rate of the production line is lowered.

For example, in a case where both the print head and the controller are mailed for repair, it takes time and effort to perform operations such as waste liquid, packing, and delivery. In addition, even in a case where a maintenance person visits, it may take a lot of time to solve the trouble. For example, when deflection leakage occurs in the deflection electrode, the deflection electrode needs to be appropriately cleaned by a solvent. Also, when a nozzle jam occurs, after a replacement nozzle is attached to the print head, an appropriate shaft adjustment must be made while taking into account individual differences of components. Such an operation may take a lot of time. Furthermore, there are many cases where the cause itself of trouble cannot be identified.

A problem to be solved by the first modification is to prevent a decrease in an operation rate of a production line even when a trouble occurs in a print head. To solve such a problem, according to the first modification, a part of the print head 1 is modularized as the head module 1B that is mountable on and dismountable from the head main body 1A. As exemplified in FIG. 3, the head module 1B accommodates the nozzle 12, the charging electrode 13, and the deflection electrode 15, and incorporates the high-voltage generation unit 18 for generating a high voltage (for example, several kv) for the deflection electrode 15.

By modularizing a part of the print head 1, even if a trouble occurs in the print head 1 during the operation of the production line (conveyance line L), the operation of the production line can be restarted only by replacing the head module 1B with another new one. Therefore, it is possible to shorten the time until trouble recovery and to prevent a decrease in the operation efficiency of the production line.

Similarly to the embodiment described above, since the high-voltage generation unit 18 is incorporated in the head module 1B, a high voltage signal caused by the high-voltage generation unit 18 is not transmitted and received between the head main body 1A and the head module 1B. Therefore, the insulation distance can be shortened, and the connecting portions between the head main body 1A and the head module 1B, that is, the first and second engagement portions 62 and 72 can be simplified or made compact. The simplification and the compactness can facilitate mounting and dismounting of the head module 1B and enhance usability thereof.

Furthermore, since the 14th valve V14 is disposed inside the head main body 1A, when the head module 1B is removed from the head main body 1A at the time of manufacturing the inkjet recording apparatus I, leakage of ink from the head main body 1A can be suppressed.

In general, the leakage of ink contaminates the surrounding environment of the factory, and thus it takes time and effort to clean the leakage of ink. In consideration of such trouble, the leakage of ink is disadvantageous in securing the operation efficiency of the production line.

On the other hand, by arranging the 14th valve V14 inside the head main body 1A to suppress the leakage of ink, it is possible to prevent the decrease in the operation efficiency of the production line.

Further, as described with reference to FIG. 2B regarding the embodiment described above, the first sensor 21 and the second sensor 22 are provided in the print head 1, and at least some electrical paths are made independent between the first sensor 21 and the second sensor 22.

In this way, even if an inconvenience occurs in one of the independent electric paths, the detection signal of the first sensor 21 or the second sensor 22 can be input to the controller 100 through the other electric path. This facilitates replacement of the head module 1B.

In addition, as illustrated in FIG. 10A and the like, by providing not only the first lock mechanism 9A but also the second lock mechanism 9B, it is possible to suppress unintended detachment due to a human error. This is advantageous in suppressing leakage of ink due to unintended detachment and securing the operation efficiency of the production line.

### <Second Modification of Inkjet Recording System S>

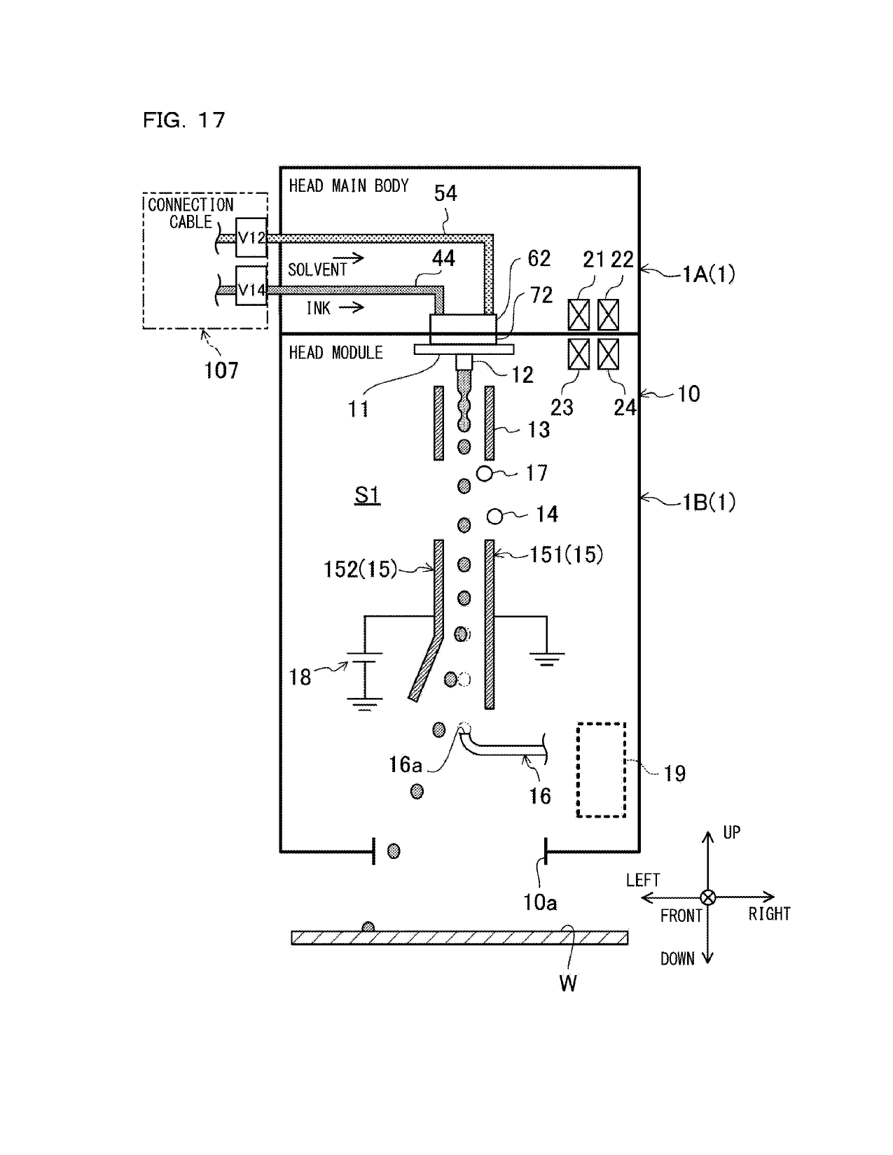

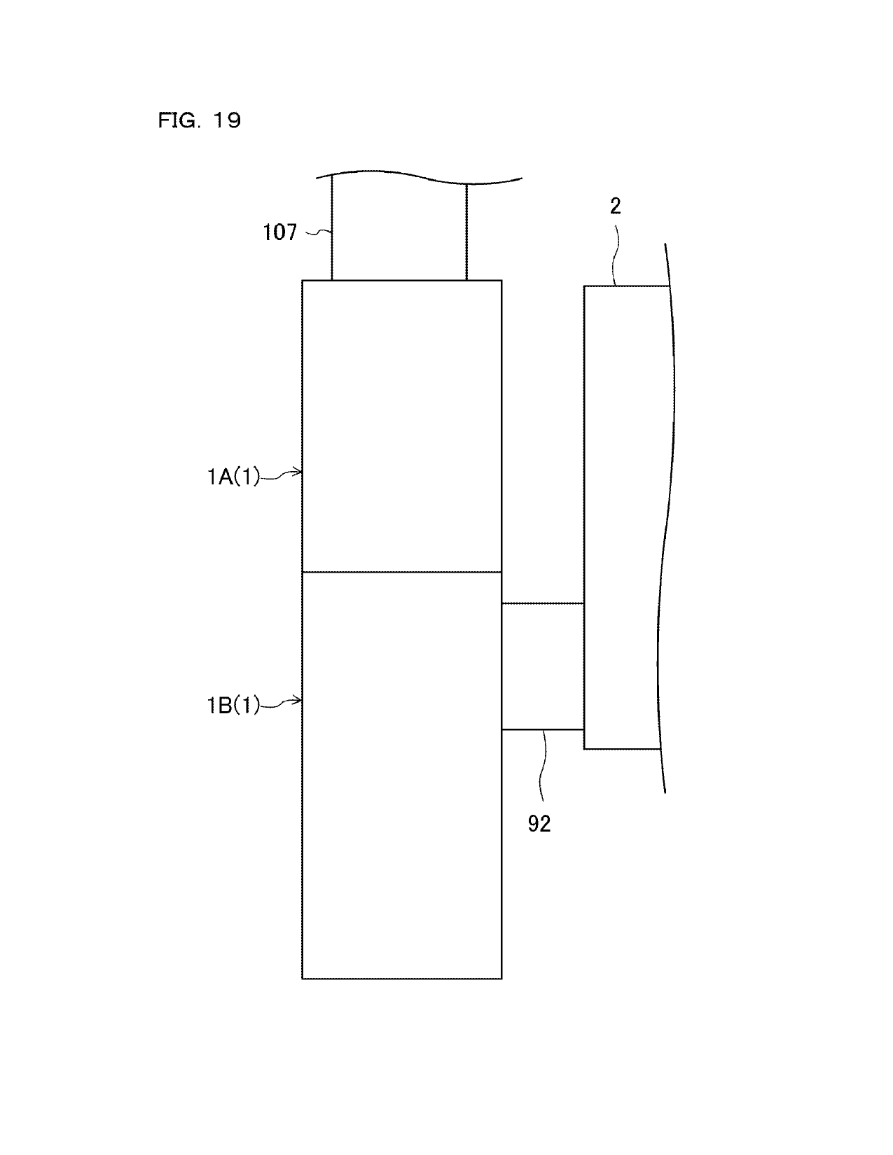

FIG. 17 is a diagram corresponding to FIG. 3 illustrating a print head 1 according to a second modification. FIG. 19 is a diagram corresponding to FIG. 18 illustrating an attachment portion 92 according to the second modification.

In the second modification, the connection cable 107 is provided with a valve (14th valve V14) that opens and closes the ink supply path to the nozzle 12. Similarly, the head main body 1A is provided with a valve (12th valve V12) that opens and closes a solvent supply path to the nozzle 12. As in the second modification, at least one of the 14th valve V14 and the 12th valve V12 may be incorporated in the connection cable 107.

As illustrated in FIG. 19, also in the second modification, the connection cable 107, the head main body 1A, and the head module 1B are connected in this order from the top. Here, the attachment portion 92 for positioning and fixing the print head 1 is connected to the head module 1B according to the second modification. The print head 1 is connected to the support member 2 via the attachment portion 92. Specifically, in the present embodiment, the attachment portion 92 extending in the up-down direction is connected to the rear surface of the head module 1B (the rear surface of the second housing portion 70 described above).

As described above, by connecting the attachment portion 92 to the head module 1B located on the distal end side of the print head 1, the landing position of the ink ejected from the head module 1B can be stabilized. As a result, the printing accuracy of the print head 1 can be stabilized.

### <Third Modification of Inkjet Recording System S>

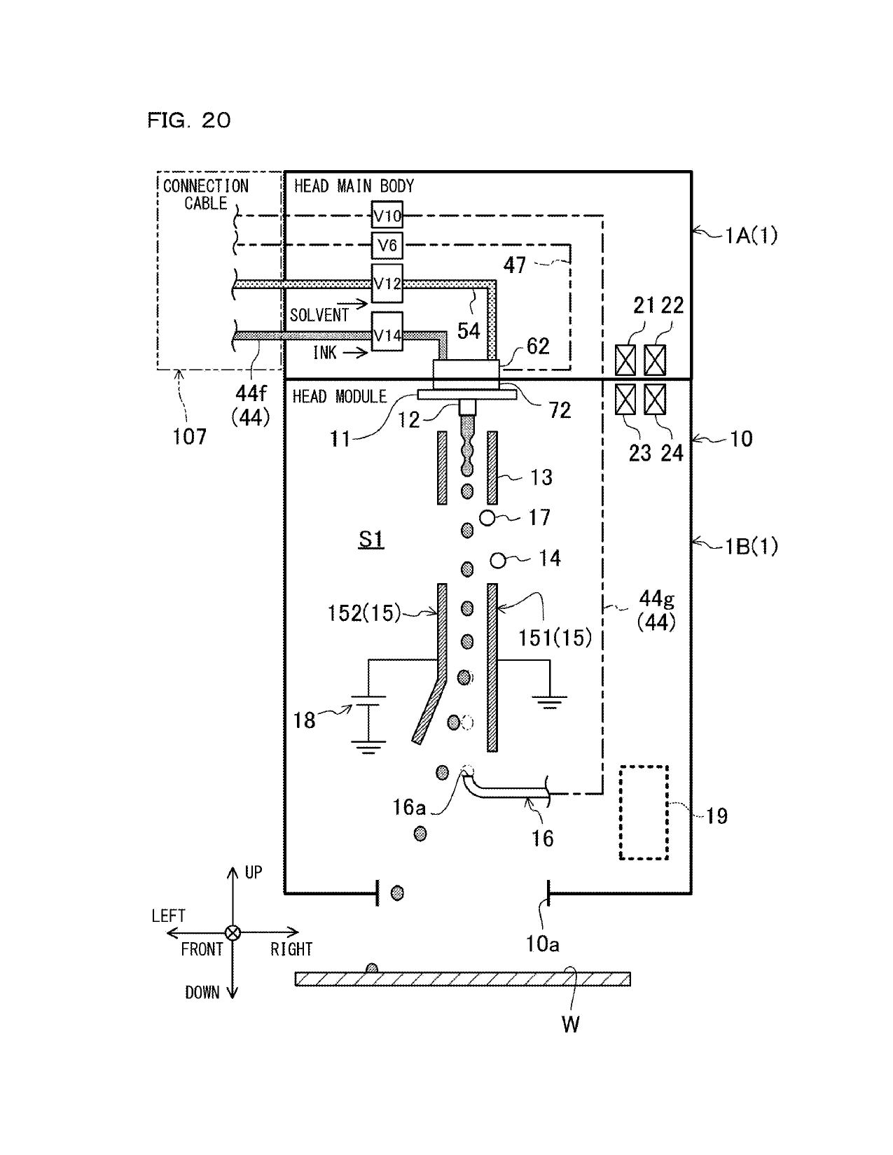

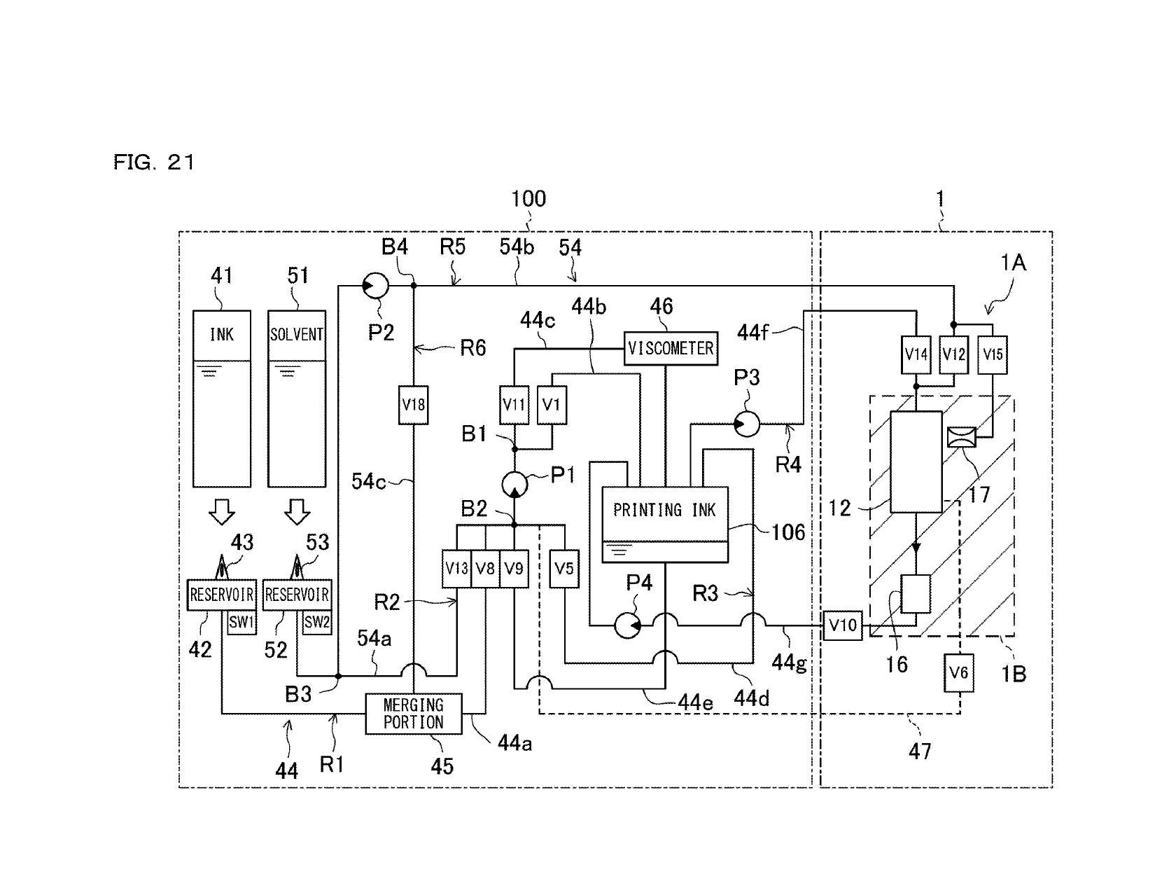

FIG. 20 is a diagram corresponding to FIG. 3 illustrating a print head 1 according to a third modification. FIG. 21 is a diagram corresponding to FIG. 4 illustrating an inkjet recording apparatus I according to the third modification. Components having substantially the same functions in FIGS. 3 and 4 and FIGS. 20 and 21 are denoted by the same reference numerals.

In the embodiment described above, the 14th valve V14 that opens and closes the ink supply path to the nozzle 12 has been exemplified as an example of the "valve" that is provided in the connection cable 107 or the head main body 1A and opens and closes the distribution path for distributing the ink between the head main body 1A and the head module 1B.

However, the "valve" according to the present disclosure is not limited to a valve that opens and closes an ink supply path to the nozzle 12. The "valve" according to the present disclosure includes a valve that opens and closes a flow path for collecting ink or a solvent between the head main body 1A and the head module 1B, such as a sixth valve V6 that opens and closes the suction path 47 and a tenth valve V10 that opens and closes the seventh ink pipe 44g (see FIG. 20). Thus, the leakage of ink from the suction path 47 or the seventh ink pipe 44g can be handled.

Here, out of the sixth valve V6 and the 14th valve V14, the member corresponding to the "valve" is incorporated in the head main body 1A as suggested in FIGS. 20 and 21. Alternatively, as in the second modification described above, at least one of the sixth valve V6 and the 14th valve V14 may be incorporated in the connection cable 107.

The "valve" may be a "valve" that opens and closes a circulation path for supplying ink or a solvent or collecting the ink or the solvent between the head main body 1A and the head module 1B, that is, a circulation path for circulating the ink or the solvent between the head main body 1A and the head module 1B.

Here, the term "valve" is used in a broad sense. That is, the "valve" according to the present disclosure includes a fluid coupling in addition to a valve member such as an electromagnetic valve or a manual cock. Specific examples of the fluid coupling include a zero spill coupler (registered trademark). In general, the zero spill coupler adopts a dripping reduction valve structure, and this structure can reduce air contamination and dripping during connection and separation. In addition, since the zero spill coupler can be connected by one-touch operation, the operation is simple and the operation efficiency is improved. In addition, a ball valve, a butterfly valve, a pressure reducing valve, or the like may be used.

### <Other Modifications>

In addition, various types of information may be stored in the storage unit 19 at the time of shutdown of the inkjet recording apparatus I (for example, when ink circulation is stopped). The information stored at that time includes at least one of "total energization time", "total startup time", "error history", and "final shutdown state".

Here, the "total energization time" is a total energization time stored in the controller 100, and is information copied to the storage unit 19 at the time of the shutdown operation.

The "total startup time" is a total startup time stored in the controller 100, and is information copied to the storage unit 19 at the time of the shutdown operation.

The "error history" is information in which the date and time of occurrence of an error is associated with an ID number indicating the type of the error.

The "final shutdown state" is information indicating whether the apparatus is normally operating in the final shutdown or is in a state of being terminated with an error at the time of the final shutdown.

What is claimed is:

1. A continuous inkjet recording apparatus comprising:
a print head that accommodates therein, a nozzle that ejects particulate ink, a charging electrode that charges the particulate ink ejected from the nozzle, a deflection electrode that deflects a flying direction of the ink charged by the charging electrode, and a gutter that recovers ink not deflected by the deflection electrode, and ejects the ink deflected by the deflection electrode to an outside;
a controller including an ink supply unit that supplies ink to the print head, and a control unit that controls ink supply from the ink supply unit to the print head; and
a cable that connects the print head and the controller and supplies ink from the controller to the print head, wherein
the print head includes a head main body to which the cable is connected, and supplies ink to the nozzle via the cable, and a head module that is mountable on and dismountable from the head main body, and accommodates the nozzle, the charging electrode, the deflection electrode, and the gutter, and
the cable or the head main body is provided with a valve that opens and closes a flow path through which ink or a solvent flows between the cable or the head main body and the head module, and the head module is provided with a high-voltage generation unit that generates a high voltage to be applied to the deflection electrode.

2. The inkjet recording apparatus according to claim 1, wherein
the valve transitions from an open state to a closed state by receiving a control signal from the control unit when the head module is removed from the head main body.

3. The inkjet recording apparatus according to claim 1, wherein
the head main body or the head module includes a sensor that detects that the head module is detached from the head main body.

4. The inkjet recording apparatus according to claim 3, wherein
the control unit prohibits application of a high voltage signal to the charging electrode on condition that the head module is removed from the head main body.

5. The inkjet recording apparatus according to claim 1, wherein
the head module includes a storage unit that stores at least one of information indicating an ink type, information on a life of the inkjet recording apparatus, and correction information for adjusting a high voltage by the high-voltage generation unit.

6. The inkjet recording apparatus according to claim 1, wherein
the print head includes
a first lock mechanism that restricts detachment of the head module from the head main body, and
a second lock mechanism that further restricts release of restriction by the first lock mechanism.

7. The inkjet recording apparatus according to claim 1, further comprising an attachment portion that is connected to the head main body and positions and fixes the print head.

8. The inkjet recording apparatus according to claim 1, further comprising an attachment portion that is connected to the head module and positions and fixes the print head.
